(19) United States
(12) Patent Application Publication
(10) Pub. No.: US 2016/0148267 A1
(43) Pub. Date: May 26, 2016

(54) SYSTEMS AND METHODS FOR TRAFFIC MONITORING AND ANALYSIS

(71) Applicant: Blyncsy, Inc., Salt Lake City, UT (US)

(72) Inventors: Mark Eric Pittman, Salt Lake City, UT (US); Patrick Barry Brown, Salt Lake City, UT (US)

(21) Appl. No.: 14/947,352

(22) Filed: Nov. 20, 2015

Related U.S. Application Data
(60) Provisional application No. 62/082,212, filed on Nov. 20, 2014.
(60) Provisional application No. 62/127,638, filed on Mar. 3, 2015.
(60) Provisional application No. 62/197,462, filed on Jul. 27, 2015.
(60) Provisional application No. 62/197,464, filed on Jul. 27, 2015.

(51) Int. Cl. G06Q 30/02; H04W 64/00; H04W 4/02

(52) U.S. Cl. CPC G06Q 30/0261; H04W 4/023; H04W 4/028; H04W 4/027; H04W 64/006; G06Q 30/0255

(57) ABSTRACT

A method of travel analytics can include: detecting a signal of a first mobile computing device (MCD) at a first location with a first signal tracker; obtaining real time travel data about the first MCD from the signal received by the first signal tracker; accessing a database having historical travel data for the first MCD; and comparing the historical travel data with the real time travel data for the first MCD to determine travel data for the first MCD. The method can include determining a mode of travel of the first MCD based on the travel data for the first MCD. The method can include predicting a travel route for the first MCD; and predicting a time of travel for the first MCD on the predicted travel route to a second signal tracker. The method can include providing a targeted advertisement on the travel route based on the travel data.

### CROSS-REFERENCE

This patent application claims benefit of: U.S. Provisional No. 62/082,212 filed on Nov. 20, 2014; U.S. Provisional No. 62/127,638 filed on Mar. 3, 2015; U.S. Provisional No. 62/197,462 filed on Jul. 27, 2015; and U.S. Provisional No. 62/197,464 filed Jul. 27, 2015, which provisional applications are incorporated herein by specific reference in their entirety.

### BACKGROUND

Tracking devices that can detect signals emitted from a mobile computing device can be used for tracking people that carry the devices. The ability to track the movement of people by using their mobile devices can provide valuable information about the patterns of their movement, commutes, and locations they visit. Such information can be processed to determine demographics based on trends in the tracked data. Now that the tracking data can be acquired, the applications for analysis of the data and use of the data can be explored.

### SUMMARY

In one embodiment, a method of travel analytics can include: detecting a signal of a first mobile computing device (MCD) at a first location with a first signal tracker; obtaining real time travel data about the first MCD from the signal received by the first signal tracker; accessing a database having historical travel data for the first MCD; and comparing the historical travel data with the real time travel data for the first MCD to determine travel data for the first MCD. The method can include determining a mode of travel of the first MCD based on the travel data for the first MCD. The method can include determining a travel route for the first MCD based on the travel data for the first MCD. The method can include predicting a time of travel for the first MCD on the predicted travel route to a second signal tracker.

In one embodiment, a method can include: analyzing the travel data for the first MCD with travel data from other MCDs; determining one or more travel data groups; and grouping the first MCD with one or more other MCDs into one or more data groups.

In one embodiment, a method can include: detecting signals of a plurality of mobile computing devices (MCDs) at one or more locations with one or more signal trackers; obtaining real time travel data about the plurality of MCDs from the signal received by the one or more signal trackers; accessing a database having historical travel data for the plurality of MCDs; and comparing the historical travel data with the real time travel data for the plurality of MCDs to determine travel data for the plurality of MCDs.

In one embodiment, the method can include processing the travel data for the plurality of MCDs to distinguish between: different modes of travel being bus, train, car, bicycle, skiing, skating, or walking for each MCD; different MCDs in a common vehicle; different MCDs for a common person; different people in a common vehicle; different travel routes for different people; different travel times for different people; different origination locations for different people; or different destination locations for different people.

In one embodiment, the method can include processing the travel data for the plurality of MCDs to determine: a common mode of travel being bus, train, car, bicycle, skiing, skating, or walking for two or more MCDs; a common vehicle having two or more MCDs; a common person having two or more MCDs; a common vehicle having two or more MCDs; a common travel route for two or more MCDs; a common travel time for two or more MCDs; a common origination location or origination area for two or more MCDs; or a common destination locations for two or more MCDs.

In one embodiment, the method can include identifying one or more common characteristics of the travel data for a first plurality of the MCDs; and grouping the first plurality of MCDs into a group.

In one embodiment, the method can include identifying the group for a targeted advertisement; and providing the advertisement to the group.

In one embodiment, the method can include identifying a targeted advertisement for the group; determining a common travel pattern for the group; and providing the advertisement at a location in the common travel pattern for the group. In one aspect, the group travels past a common location during the travel pattern, and the advertisement is provided at that common location.

In one embodiment, the method can include: identifying a first traffic pattern for one or more groups of MCDs; identifying a targeted event in a geographical location of the first traffic pattern; performing travel analytics after the targeted event; and determining whether or not there is a change from the first traffic pattern to a second travel pattern in response to the targeted event. The method can also include: determining increased traffic to a first location after the targeted event compared to before the targeted event, wherein the targeted event is an advertisement for an entity at the first location; and determine a cost of the advertisement to charge the entity based on the change from the first traffic pattern to a second travel pattern. Additionally, the method can include: determining an entity at a first location on the travel route; obtaining an advertisement for the entity; and providing the advertisement at a second location on the travel route, the second location being passed before passing the first location on the travel route.

In one embodiment, the method can include: measuring signal strength from the MCD with a signal tracker; measuring duration of signal detection with the signal tracker; identifying the start of signal detection; identifying the end of signal detection; triangulating the location of the MCD relative to one or more signal trackers; or using trilateration to determine the location of the MCD relative to one or more signal trackers.

In one embodiment, the method can include: detecting a plurality of MCDs at a signal tracker in a defined timeframe to obtain real time travel data; comparing the real time travel data at that signal tracker with historical travel data for that signal tracker; and determining traffic volume for that signal tracker at that timeframe. The method can also include: identifying a potential advertisement; identifying a target group to receive the potential advertisement; identifying an advertisement location for the potential advertisement that is passed by the target group; and identifying a timeframe for presenting the potential advertisement to the advertisement location at the timeframe. The method can also include determining an advertisement rate for the potential advertisement at the advertisement location and timeframe based on the traffic volume of the target group.

In one embodiment, the method can include: processing data of the one or more data groups; identifying a travel group; predicting a travel route for the travel group; and predicting a time of travel for the travel group on the predicted travel route to a second signal tracker.

In one embodiment, travel data can be used to determine when a likely MCD will arrive at a given location. As such, the travel data can be analyzed to predict when and where a traveler (e.g., via the MCD) will arrive after traveling. Such a prediction can be based on the travel route and travel route historical data. Also, a given location and time can be identified, and a traveler likely to arrive at that given location and time can be identified, as well as groups of such travelers. The travel data can be analyzed in such a way that habits and travel patterns that are repeated can be used to make predictions of travel routes, travel times, time leaving origination location, location of origination location, time of arrival at destination, and destination location, among other parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A shows an embodiment of a system that includes a mobile computing device (MCD), signal tracker, network, and server computing system.

FIG. 1B shows an embodiment of a signal tracker that can be used to detect signals of MCDs.

FIG. 1C shows an embodiment of traffic monitoring and analysis system that includes a plurality of MCDs in proximity with a signal tracker, and a plurality of signal trackers communicatively coupled through a network to a Server Computing System (SCS).

FIGS. 1D-1 and 1D-2 show an embodiment of an operation al protocol with the system of FIG. 1C.

FIG. 2 shows a map having a schematic representation of a plurality of signal trackers of a signal tracker system being deployed along a highway system of a geographical area, where the signal trackers are distributed in a manner to track MCDs, which are shown by the stars.

FIG. 3 shows a street system of a metropolitan area having a signal tracker system.

FIG. 4 illustrates an example of pedestrian traffic at an outdoor mall that can be tracked with a signal tracker system.

FIG. 5 illustrates an embodiment of a signal tracker and its components.

FIG. 6 shows an example computing device that is arranged to perform any of the computing methods described herein.

FIG. 7 illustrates a ski resort having signal trackers (black donut) on lifts and runs.

FIG. 8 illustrates a parking facility having signal trackers.

FIG. 9 illustrates a stadium having signal trackers.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

System and Method for Real-Time Traffic Monitoring and Traffic Management

Generally, the technology relates to a traffic monitoring device that can monitor traffic to obtain traffic data and a system having a plurality of the traffic monitoring devices communicatively coupled through a network to a server computing system that can receive and analyze the traffic data. The data can be analyzed through various data analytic protocols to identify information about the individual travelers and their contribution to the traffic as well as their real time traffic action and historical traffic patterns. The traffic can be related to any mode of transit, whether using a fuel or electricity powered vehicle or human powered vehicle or human foot traffic.

In one embodiment, the technology includes a smart signal tracker that can track traffic passing within a defined distance from the signal tracker. The signal tracker can include one or more signal detectors that can detect one or more types of signals from the traffic. The embodiment operates with traffic entities that have mobile computing devices (e.g., MCDs) that emit one or more types of signals that can be detected by the one or more signal detectors of the signal trackers. The MCDs can emit WiFi, Bluetooth, and cellular signals, among other types of signals. However, the description of the technology will describe implementations that operate by detecting these three types of signals as examples, but it should be recognized that the signal tracker can be outfitted with other types of signal detectors and may detect other types of signals. The signal tracker receives traffic data from the MCDs and transmits some or all of the traffic data to a server computing system.

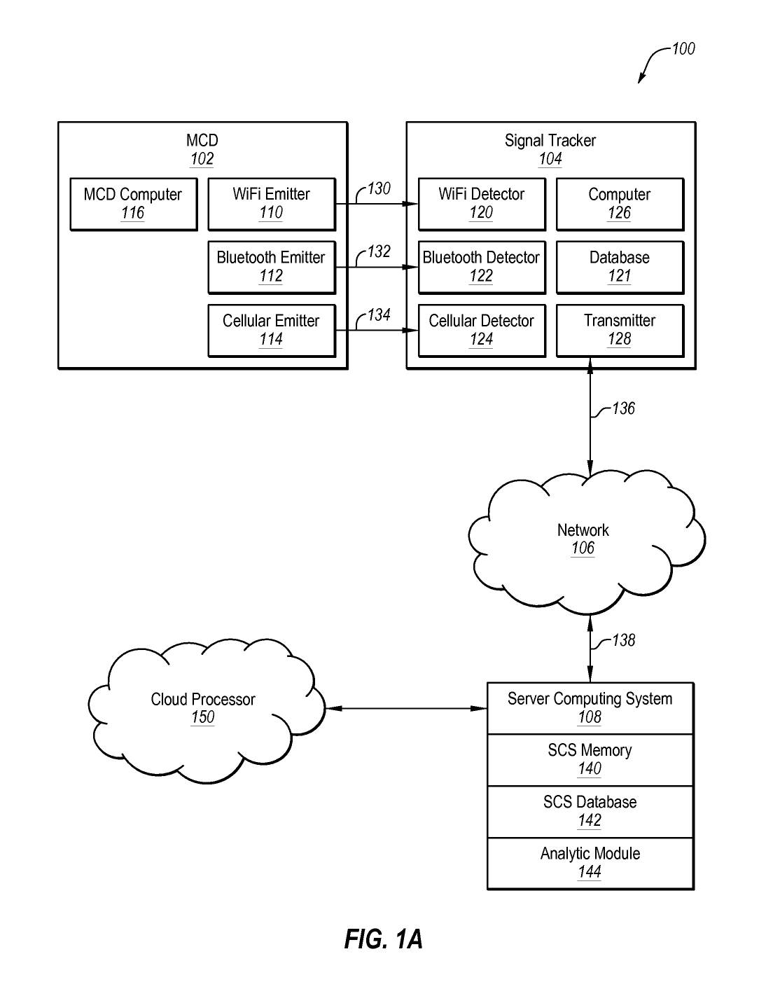

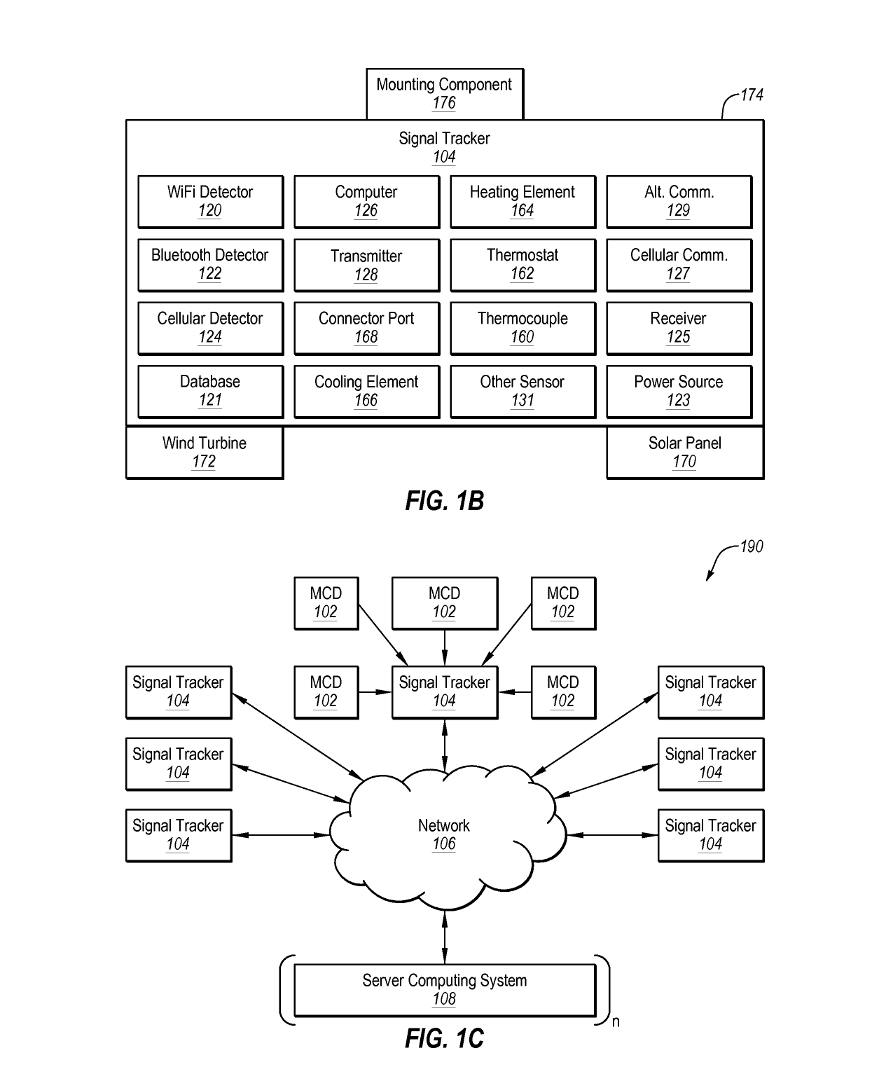

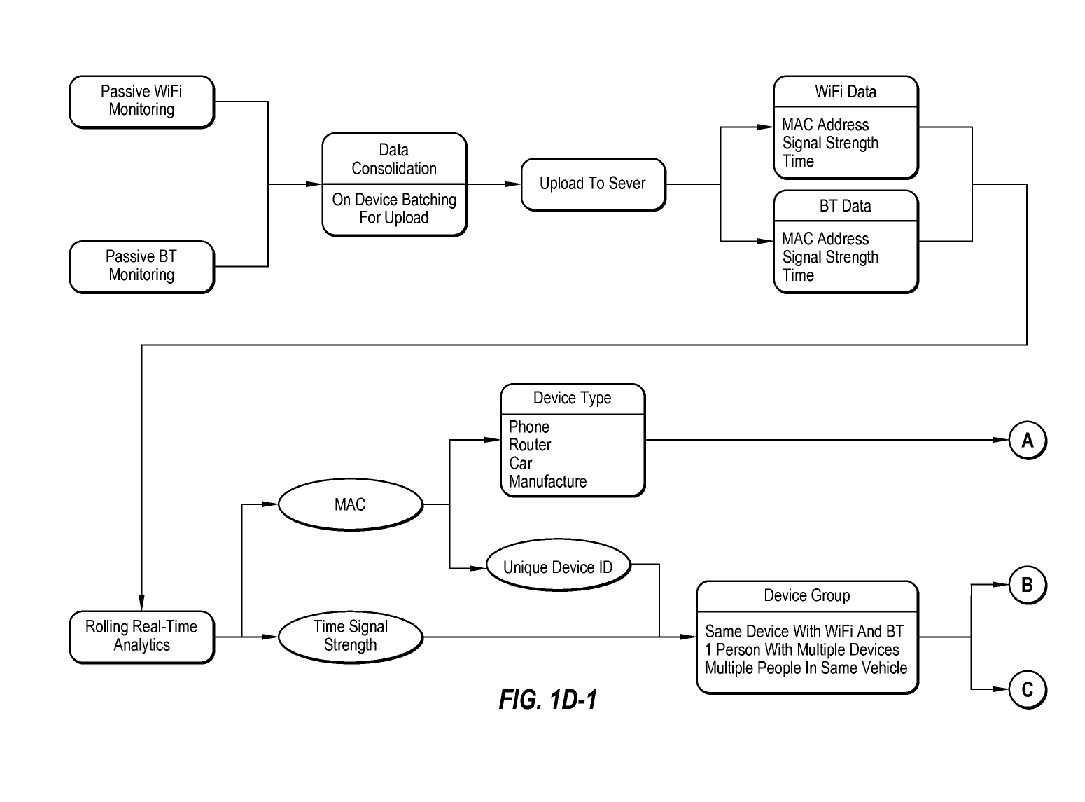

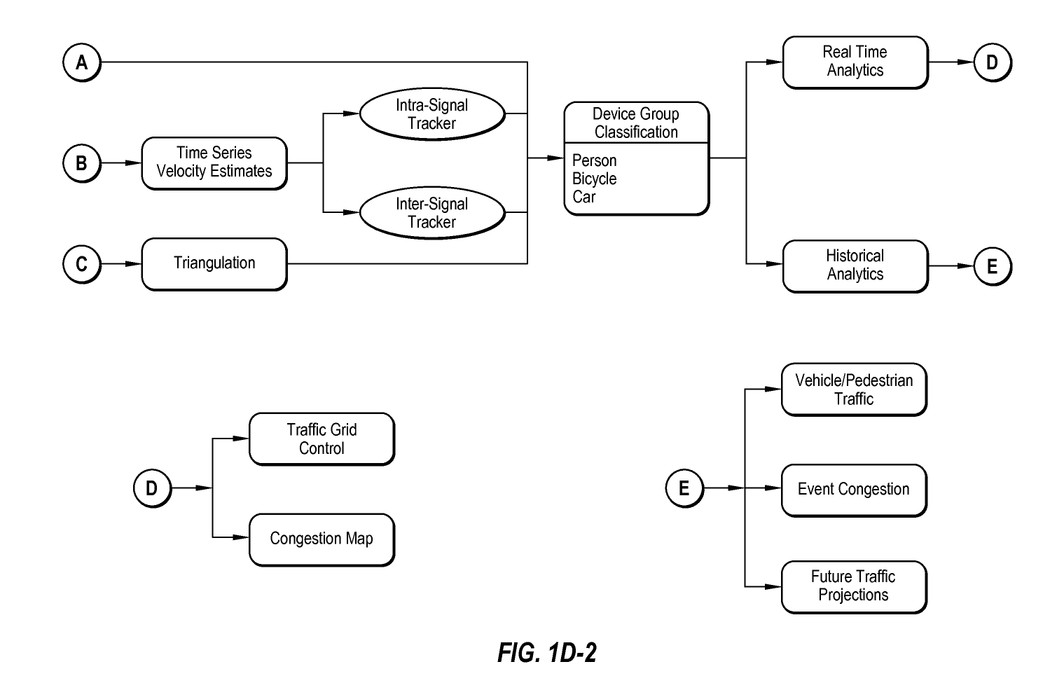

FIG. 1A shows an embodiment of a system 100 that includes an MCD 102, signal tracker 104, network 106, and server computing system 108. The MCD 102 is shown to have: a WiFi emitter 110 that is configured to emit a WiFi signal 130, such as when the MCD 102 is searching for a WiFi network to join; a Bluetooth emitter 112 that is configured to emit a Bluetooth signal 132, such as when the MCD 102 is searching for a Bluetooth network; and a cellular emitter 114 that is configured to emit a cellular signal 134, such as when the MCD 102 is searching for a cellular network. Correspondingly, the signal tracker 104 is shown to have a WiFi detector 120 that is configured to detect a WiFi signal 130, such as a WiFi signal from an MCD 102 that is searching for a WiFi network to join; a Bluetooth detector 122 that is configured to detect a Bluetooth signal 132, such as a Bluetooth signal from an MCD 102 that is searching for a Bluetooth network to join; and a cellular detector 124 that is configured to detect a cellular signal 134, such as a cellular signal from an MCD 102 that is searching for a cellular network to join. The MCD 102 can include an MCD computer 116 that provides MCD data to the WiFi emitter 110, Bluetooth emitter 112, and/or cellular emitter 114, where such data is embedded in the signals (e.g., WiFi signal 130, Bluetooth signal 132, and/or cellular signal 134) and the data content of such signals is well known in the art. The signal tracker 104 can include a signal tracker computer 126 that receives data for the detected WiFi signal 130, Bluetooth signal 132, and/or cellular signal 134 received from the MCD 102, and performs any function with the data as described herein, which may or may not include data processing. The signal tracker 104 also includes a signal tracker transmitter 128 that can transmit a signal tracker signal 136 having signal tracker data to the network 106. The network 106 can then pass the signal tracker data to the server computing system (SCS) 108 through a network signal 138. The server computing system 108 can perform the data analytics described herein. The transmitter 128 may also be able to transmit data to the MCD 102.

In one example, the signal tracker 104 collects Wi-Fi signals 130 and/or Bluetooth signals 132 (e.g., Bluetooth being “BT”) and/or cellular signals 134, and obtains data from the collection of such signals, where such data can include for example MAC address, signal strength, time, and location, from the MCD 102. The collected data is then consolidated onboard the signal tracker 104, such as in the signal tracker computer 126, such as in a signal tracker database 121 (FIG. 1B). The signal tracker computer 126 processes the collected data to obtain relevant data and to exclude irrelevant data that is removed from the collected data. The removed data may be retained in the signal tracker database 121, or it can be purged. The data is then transmitted to the SCS 108 via the network 106, which can be a real time data transfer, or the data can be batched by the signal tracker computer 126 and uploaded to the SCS 108 in a batch mode. The SCS 108 can receive the uploaded data from the signal tracker 104 and temporarily save the data in a SCS memory 140 for later insertion into the SCS database 142. The upload process (e.g., background upload process) can pick up the data in an order (e.g., sequentially, level of importance, or marked data) and insert the data into the SCS database 142. The SCS 108 includes an analytic module 144 that can analyze the data in various analytical protocols, or it can transmit the data to a cloud processor 150 for performing the analytics. The analytic module 144 can implement analytic processing of the data, and then periodically update analytics either on a processor associated with the analytic module 144 or via cloud-computing servers (e.g., cloud processor 150).

The data analysis can include the MAC address of the MCD 102 being classified. into: device type based on manufacturer, model, and other specifications for later use. The traffic data including the unique MAC address, time detected by the signal tracker 104, and signal strength received from the signal tracker 104 can be used in the data analytics.

In one example, a single MCD 102 can emit multiple signals (e.g., WiFi, BT, cellular, or other) that can be detected by the signal tracker 104. However, a mobile. entity, such as a vehicle (e.g., car, truck, bus, bicycle, skates, skateboard, skis, etc.) can include one or more unique persons, and each person can include one or more unique MCDs 102. Accordingly, a mobile entity may have more than one MCD 102 being detected simultaneously by the signal tracker 104, and the data thereof provided to the SCS 108. The one or more MCDs 102 within the same mobile entity can be filtered, controlled for and adjusted directly on signal tracker computer 126, SCS 108, and/or cloud processor 150. The signal tracker 104 can generate data or receive data from the SCS 108 or cloud processor 150, and either take an action or relay information back to the SCS 108 or cloud processor 150. The signal tracker 104 can relay a data signal directly to other electronic or mechanical equipment (e.g., examples include but are not limited to traffic lights, street lights, billboards, monitors and mobile applications), and such electronic or mechanical equipment may implement an operation or change an operation in response to the data on the data signal.

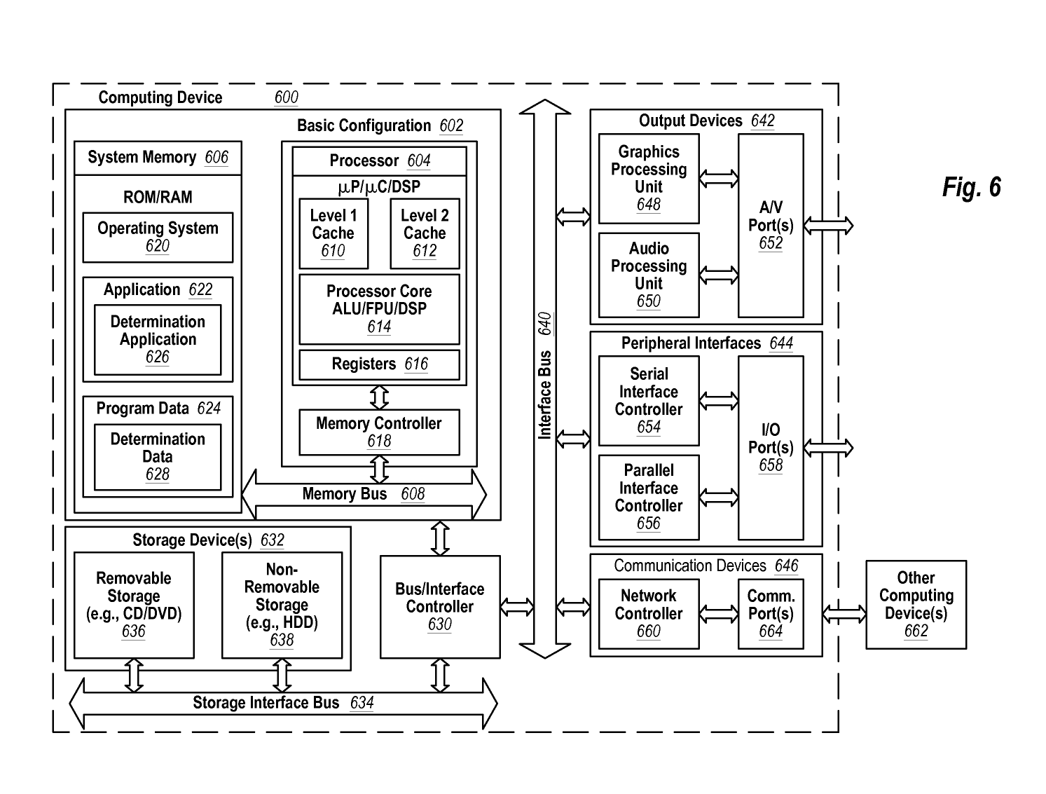

The signal tracker 104 is described in more detail herein and in reference to FIG. 1B. Generally, the signal tracker 104 can include a signal tracker computer 126, which can include aspects of any common computer, such as exemplified by FIG. 6. The signal tracker computer 126 can include a processor that operates as any computing processor. The components of the signal tracker 104 may be connected together and operate as understood by one of ordinary skill in the art. The signal tracker 104 can have a power source (e.g., battery or 110 V or 220 V or any other) 123 or receive power from an outside source. The power is provided to each component of the signal tracker 104 either by channeling power through the individual components or by using cables, wires or other means to provide the needed power to each component. This can be accomplished by using a USB-hub or similar device to facilitate power transfer. The signal tracker computer 126 can include circuitry for operation of the signal tracker 104. The circuitry can be used for capturing: WiFi MAC addresses and associated data such as signal strength and time the signal was first captured and duration of time the signal is detected, Bluetooth address (e.g., BD_ADDR) or MAC address and associated data such as signal strength and time the signal was first captured and duration of time the signal is detected, and cellular pseudonoise code (e.g., PN code) or MAC address and associated data such as signal strength and time the signal was first captured and duration of time the signal is detected. However, other signals from the WiFi Bluetooth, or cellular emitter with other information may also be used. The signal tracker 104 can use the identification of the WiFi, Bluetooth, and/or cellular modules, or it can group two or more of these identifiers together and/or create an identification number for the MCD 102 based on one, two, or three of the WiFi, Bluetooth, and/or cellular identifiers. This allows each unique MCD 102 to be identified and tracked separately. The signals from the MCD 102 can act as a fingerprint that can be tracked by the signal tracker 104.

The signal tracker 104 can have a signal tracker transmitter 128 that includes the electronics, hardware, software, and antennae to transmit data, such as to the network 106 or other signal trackers 104 or MDCs 102. The signal tracker 104 can have a signal tracker receiver 125 that includes the electronics, hardware, software, and antennae to receive data from the network 106 or other signal trackers 104 or MDCs 102. The transmitter 128 and receiver 125 can be combined into a transceiver. The signal tracker 104 can communicate with the network 106 or other signal trackers 104 or MDCs 102 in any possible way or combination of ways. In one way, the communication can be via Bluetooth Low Energy. In another way, the communication can be via any communication mode, Ethernet, Wi-Fi, 3-4G or GSM or the like. The signal tracker 104 can include a WiFi detector 120 that has one, two or three or more WiFi antennas, which can be part of the WiFi detector 120. The WiFi detector 120 can gather WiFi data to passively gather MAC addresses and other data (e.g., signal strength and signal detection duration and/or time) from any MCD in proximity to the signal tracker 104. The WiFi detector 120 may be configured to transmit data via WiFi, such as to the MCD 102, or to send/receive data with the SCS 108 or cloud processor 150. The signal tracker 104 or WiFi detector 120 may use externally or internally mounted directional or omni-directional antennas. The WiFi detector 120 may be configured as a WiFi module for WiFi operation and processing.

The signal tracker 104 can include a Bluetooth detector 122 that can perform a Bluetooth gathering function and a Bluetooth transmission function. The Bluetooth gathering function can use the device/antenna that gathers Bluetooth MAC addresses and signal strength as well as other Bluetooth data. The Bluetooth transmission function can use a Bluetooth module or built in Bluetooth to transmit a message or short code to devices (e.g., MCDs) in its range that have identified themselves as looking to receive information from a mobile APP or partner APPs. The Bluetooth detector 122 may be compatible or not compatible with an “iSignal tracker” protocol and other similar protocol often referred to as “BLE”. The Bluetooth detector 122 may use externally or internally mounted directional or omni-directional antennas.

The signal tracker 104 can include a cellular detector 124 that can perform gathering functions and/or transmission functions as described herein. That is, the cellular detector 124 can detect a cellular signal and obtain identification information as well as other data as described herein. The signal tracker 104 may also include a cellular communicator 127 that can be implemented similar to a cellular phone to send and/or receive data, such as with the network 106, SCS 108, or cloud processor 150. The cellular communicator 127 can use cellular signals (e.g., 2G/3G/GSM or other) to send/receive data. The cellular detector 124 and/or cellular communicator 127 can use externally or internally mounted directional or omni-directional antennas.

The signal tracker 104 may also include an alternative communicator 129, which can be a transmitter, receiver, and/or transceiver so as to allow for alternative send/receive options. The alternative communicator 129 can use undefined/defined radio spectrum, such as specifically the ability to easily plug in a module that transmits and/or receives signals using any type of communication (e.g., microwave signals). The alternative communicator 129 may use externally or internally mounted directional or omni-directional antennas.

The signal tracker 104 can store data internally in the signal tracker database 121 or other memory device, which stored data is either encrypted or not encrypted. The signal tracker computer 126 can filter the data for unwanted or wanted types of data and/or signals based on the type of signal, the strength of the signal, the type of MCD, model of MCD, or time the MCD comes into or goes out of range of the signal tracker as well as the duration the MCD is within range.

The signal tracker computer 126 can include a processor capable of running embedded Linux or other operating systems, and can perform calculations, process data, and execute commands for controlling all connected components of the signal tracker 104, while also being able to create a mesh network between signal trackers 104 in appropriate proximity. The signal tracker computer 126 can include on board memory that is sized appropriately, such as appropriately sized RAM, external/movable memory such as having the capability to attach a 128 GB micro-SD or SD card or other portable memory device. The signal tracker computer 126 can include a user interface or be pluggable to a user interface, which provides the ability to directly or remotely control and upgrade software via 3-4G or GSM.

The signal tracker 104 can include components for environmental management so that the signal tracker can operate at cold and hot temperatures commonly found in the environment of use. Such components can include a thermocouple 160, thermostat 162, heating element 164, and cooling element 166. The components for environmental management can use the thermocouple 160 as an on board temperature monitor and the thermostat 162 can be used for controlling the heating element 164 and/or cooling element 166 in response to the temperature provided by the thermocouple 160. The thermostat 162 may be preprogrammed for temperature regulation or it may be controlled by the SCS 108 or cloud processor 150. A number of thermocouples 160 can measure temperatures inside and/or outside of the signal tracker 104. Also, external heating capabilities can be provided by a connected solar panel 170 or wind turbine 172, which can be controlled by the thermostat 162.

The signal tracker 104 can include various external connector ports 168, which can be configured to receive any type of pluggable, such as for data communication with a separate device or a network. Examples can include Ethernet ports, 12C, USB, SPI interface, or the like, and any number of external connector ports 168 can be included. Also, the signal tracker 104 can include other sensors 131, such as those that can sense the environmental conditions around the signal tracker 104, where a weather sensor is an example.

The signal tracker 104 can be operated by any type of power source 123, such as being capable of accepting, for example, a +5V signal, through a micro-USB from a 110-120 V converter or a 12 V converter from either solar panels or batteries or any pluggable or hardwired power source. The signal tracker 104 can monitor power usage over time by recording and reporting data on power consumption and transmitting such data to the SCS 108, such as via WiFi, 3-4G or GSM.

The power source 123 may include a battery system that can be run off of harvested energy that is sufficient to run the signal tracker 104. The power source 123 may up or down convert power for compatibility with other elements of the signal tracker 104. The power source can provide power or battery management, so that it provides a minimum voltage of 5V up to 24V, and may be at 2 A, such as from a harvesting source (e.g. solar panel 170 or wind turbine 172, or other natural power harvesting component). The power source 123 can use or connect to rechargeable batteries (e.g. LiFo, Nickel, Cadmium, etc.), which batteries can be interchangeable. The power source 123 can use a defined voltage of batteries to plug into a power board. The power source 123 can be unregulated 5V to 24V and up-to 2A. Power can be from two sources simultaneously (e.g. wind and solar). The power source 123 can also be regulated 5V to 24V power up to 2A, which may be obtained via USB or other cable and or protocol. The power source may be hard wired or plugged into a standard outlet or custom outlet.

A powered heat cable can also be included, which is a connection to a mask/material that runs behind an external solar panel to heat an element in snow/cold weather situations. A case 174 can be used to house the signal tracker 104 and components thereof, which may have an integrated or removable solar panel 170 or wind turbine 172. The solar panel 170 and/or wind turbine 172 can be attached to the case 174 so that either can be removed or can pivot, automatically or via manual adjustment, towards the sunlight or wind, and have the ability to be removed if not needed. The case 174 can be configured to be able to withstand summer and winter weather conditions in harsh areas such as ski resorts or deserts, low temperatures (−20° F.), and high temperatures (125° F.). The case 174 can be shock resistant to protect from falls, such as from a height greater than 10 ft. The case 174 can include mounting components 176 so as to be easily mountable and installable in almost any environment (e.g., trees, concrete walls, poles, round or square surfaces or objects).

FIG. 1C shows an embodiment of traffic monitoring and analysis system 190 that includes a plurality of MCDs 102 in proximity with a signal tracker 104, and a plurality of signal trackers 104 communicatively coupled through a network 106 to an SCS 108. While only one SCS 108 is shown, such SCS 108 may include multiple computers, or be at multiple locations, and generally function as a cloud processor 150. As such, there may be “n” SCS 108s in the system 190, where “n” is any integer.

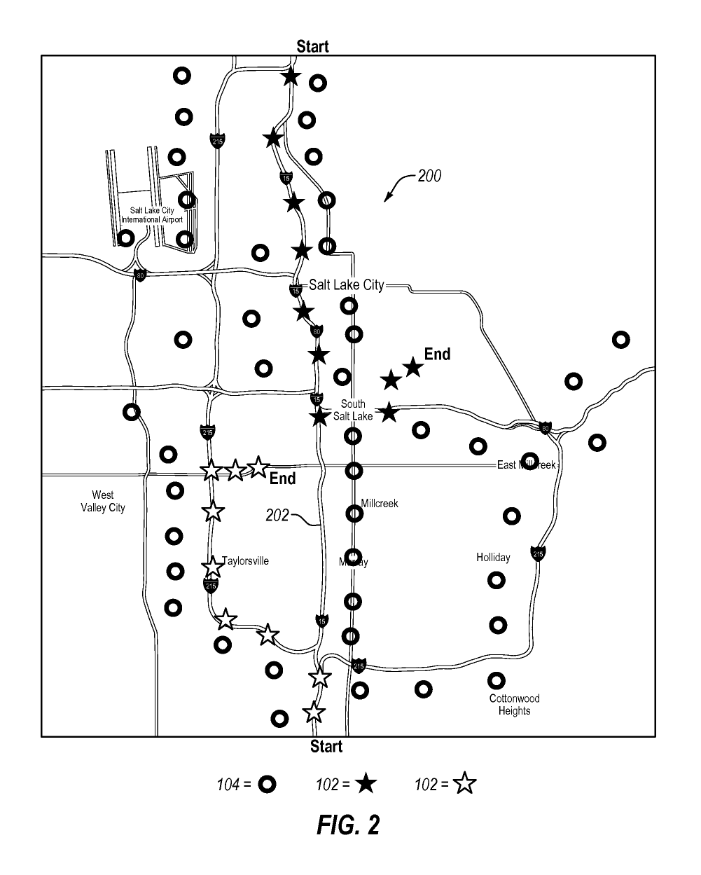

FIGS. 1D-1 and 1D-2 show an embodiment of an operation al protocol with the system of FIG. 1C. As can be seen, the signal tracker 104 can be utilized by passive signal monitoring of an MCD, such as WiFi, BT, cellular, or other signal monitoring. The data obtained from such monitoring can be obtained by the signal tracker 104, and then consolidated and uploaded to a server, such as the SCS 108. The SCS 108 can process the data to obtain information such as MAC address or other unique MCD identifier as well as data regarding the MCD 102 entering a signal tracker zone around the signal tracker 104 where the MCD 102 can be detected, such as the time of first detection, time of last detection, duration of time residing in the signal tracker zone, as well as any other data provided by the signals emitted from the MCD 102. The SCS 108 can perform many calculations and make determinations regarding the MCD being within the zone, such as rate of travel, direction of travel, road or traffic routes, associated other MCDs located in proximity to one MCD 102, groups of MCDs 102, singular MCDs 102 in packs (e.g., traffic pack of different entities), or other information. This information can be obtained at each signal tracker 104, and the same MCD 102 can be tracked at other signal trackers in the traffic system, so that a complete traffic pattern for one MCD 102, a group of MCDs 102, or packs of singular MCDs 102 can be obtained for a given time period or travel period. The information can be tracked in real time and computed, and the information can be tracked over a plurality of days, and an historical traffic pattern can be obtained for the one or more MCDs 102. Based on historical traffic and travel patterns for a single MCD 102 or group of MCDs 102 or pack of individual MCDs 102, predictions for traffic routes and travel patterns can be predicted for these MCDs 102. For example, based on historical tracking over days, weeks, or months, the routine or customary traffic routes and travel patterns can be identified. For example, a person having an MCD 102 may travel to work at a certain time or without a certain timeframe every weekday, and thereby such a common entry location and final destination for a travel route may provide an indication of where the person (e.g., MCD 102) is originating from and where they are going in a routine, so that the routine of the MCD 102 can be predicted.

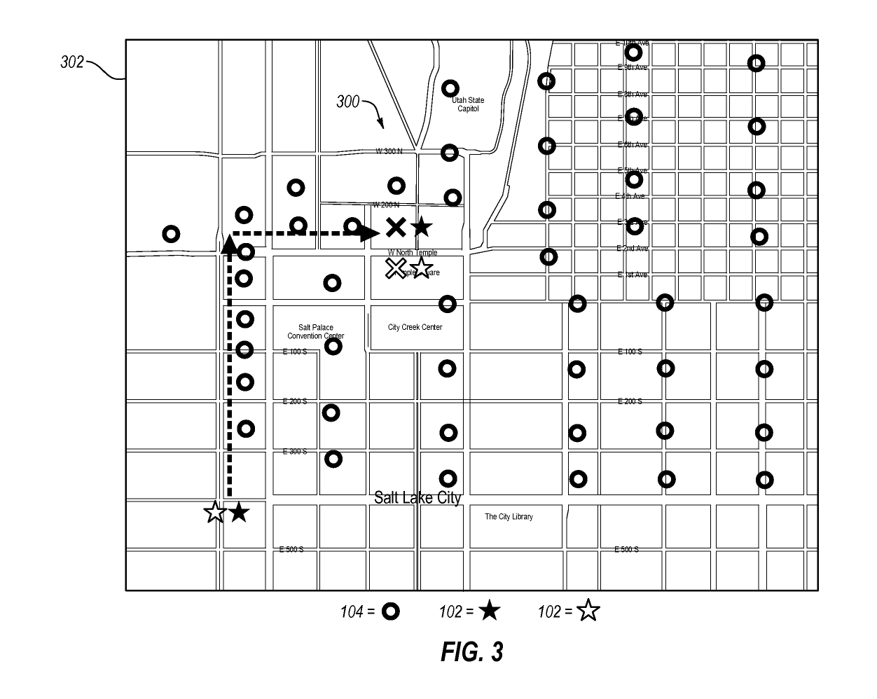

FIG. 2 shows a map having a schematic representation of a plurality of signal trackers 104 of a signal tracker system 200 being deployed along a highway system 202 of a geographical area, where the signal trackers 104 are distributed in a manner to track MCDs 102, which are shown by the stars. Note that two different MCDs 102 are shown for illustrative purposes. The signal tracker 104 zones may overlap, or there may be gaps between signal tracker 104 zones. As such, only one or a plurality of signal trackers 104 can detect a single MCD 102 at a specific time point. The signal trackers 104 can be at any location associated with the highway system, and may include signal trackers 104 at entrances and exits, interchanges, junctions, or any location therebetween. As shown in FIG. 3, the surface streets may also have a signal tracker system 300 to track the MCDs 102 before entering or after exiting the highway system. As shown, the black star MCD 102 enters the highway system (e.g., Start) and travels south on a highway, takes an interchange to a different highway to travel east, and then exits onto surface streets before arriving at a destination (e.g., End). The white star MCD 102 enters the highway system (e.g., Start) and travels north, takes an interchange to a different highway to travel west then north, and then exits onto surface streets before arriving at the destination (e.g., End). As such, the system can track each MCD 102 separately along their travel route. This allows tracking a single MCD, and thereby the person having the MCD 102 can be tracked. This allows for tracking where the MCD 102 is going and over time it allows for determining habits or routines or places the person owning the MCD 102 goes.

FIG. 3 shows a street system 302 of a metropolitan area having a signal tracker system 300; however, it should be recognized that any geographical area can have a signal tracker system 300. Here, only the signal trackers 104, shown as donuts, along the travel path of the MCD 102, shown by the dashed area, are shown. However, the signal trackers 104 can be anywhere in any distribution, in any concentration, and in any degree of having signal tracker 104 zones overlap or be distinct and separated by gaps. The black star MCD 102 and white star MCD 102 appear to be traveling together, such as in a common vehicle. Here, the final destination for the black star MCD 102 is shown by a black “X” that marks the spot where the black star MCD 102 ceases to travel; however, the final destination for the white star MCD 102 is shown by the white “X”, which is a different final location compared to the black star MCD 102. This indicates that these two separate MCDs 102 are for two different people that rideshare or otherwise traveled together to a parking spot, and then each MCD 102 goes on to their own final destination, such as different work locations. This example shows the ability to track MCDs 102 that in some periods move in a common travel route and then separate to their own final locations, and each can be tracked separately. Over an historical context of days or weeks or months, if this travel pattern occurs frequently in a similar timeframe each day, then these people may travel together such as in a carpool, and then separate to travel to their individual job locations. On the other hand, if the tracking only occurs once in an historical period, then it may be a one-off travel route. Data processing can make such determinations, where both can be useful for different contexts, as described herein. The signal trackers can be at intersections, on traffic poles, in traffic lights, on cables between poles, on power poles, on street signs, on trees, on buildings, in buildings, and at any location therebetween. The signal trackers 104 can be in plain sight or camouflaged and/or hidden. While only one MCD 102 travel route is shown, the signal tracker system can track any number of MCDs 102.

The location data of an MCD 102 at any given instant can be presented on any coordinate system, such as a map coordinate, street coordinate (e.g., address), or GPS coordinate, or the like.

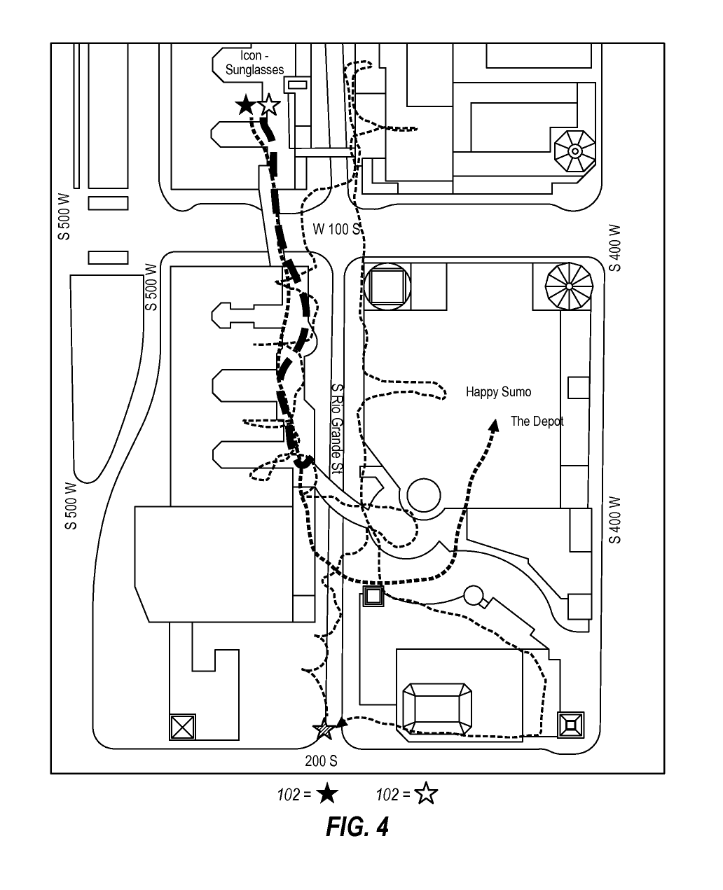

FIG. 4 illustrates an example of pedestrian traffic at an outdoor mall that can be tracked with a signal tracker system. Here, the black star and white star MCDs 102 are at a common location for a long duration, such as being at a store for work. Then, at a common time, such as lunch, they both travel together for some distance before separating to their own eating establishments. The signal tracker system allows for the tracking and the traffic monitoring system allows for the data filtering and processing to determine that the MCDs 102 are together for long periods, probably a job environment, and separate for shorter periods, probably for a break or lunch. This data can be helpful to filter out worker MCDs 102 at a job, compared to a striped star MCD 102 that is at the mall to shop. The difference in traffic pattern and routes can be used to make the determination of which MCD 102 to target for shopping advertisements, compared to the MCDs 102 to target for lunch advertisements or coupons for places they frequent often.

The signal tracker system can obtain information for the traffic monitoring system to make determinations of the travel routes and patterns of moving people into the city or into a metro area as well as moving within such areas. The data can be meshed with map data and location data so that the places the MCDs visit can be determined and analyzed. This allows for determinations of what the MCD is doing, how the MCDs move to certain places, because the system is monitoring their location and traffic pattern, whether in a vehicle and/or pedestrian.

The system is configured to track an MCD, such as a phone, a tablet, a connected car, or any other MCD that can be tracked as described herein. This allows the system to process data to identify one or more MCDs associated with a common person, and to associate a person with a group of people with a similar travel pattern, or common destination. The travel information for a particular MCD or group of MCDs can be obtained at any rate of travel, and the rate of travel can indicate travel by car, bicycle, or pedestrian travel. The data can be processed and provided to an entity for targeting advertising based on an MCD or group of MCDs with a common travel pattern that occurs repeatedly within certain timeframes of workdays or other times, where such data can be used for determining a certain advertisement to be presented on an electronic billboard at a certain time or over a certain timeframe. This allows the data to be used to predict when to advertise certain products that may be targeted to an MCD or group of MCDs. This allows the signal tracker system to obtain data for an advertising system to better target the people who are passing the electronic advertisements.

In one embodiment, MCD traffic volume can be determined so that the number of MCDs passing a certain electronic advertisement can be used to calculate a price for that advertisement, where the price can be based on per MCD in a given timeframe. For example, the historical and real time MCD traffic density for a location can be determined, and an electronic billboard at that location can provide targeted advertisements at a cost associated with the historical MCD traffic density or real time MCD traffic density. In another example, a business in a first geographical location can rent time on an electronic billboard in a second geographical location when it is determined that a high enough number of MCDs of people that originate (e.g., live) from the first geographical location travel past the second geographical location. The rental fee for such a targeted advertisement protocol can increase because the data shows people from the first location are likely to see the advertisement for the business in the first location as the people pass the second location.

The data processing can be conducted to obtain information that is useful for any entity, such as a business. In one aspect, if a business is interested in placing a store (e.g., clothing store, restaurant, etc.) at a certain location, then the data can be processed to identify the number of people, the type of people, the location of the homes of people, the estimated earnings of people, the destinations of people or other data parameters, in order to make a determination of whether or not it is business-wise to place a store at that location. The data can be processed to determine whether the people are likely candidates to go to the store based on their travel patterns in real time and historically. In one example, a business is interested in placing a restaurant at a defined location, and traffic data related to that location for people that pass that location can be obtained and provided to the business. This may include tracking people that pass this location and are often determined to be customers of similar types of restaurant businesses, and thereby prospective customers. The decisions can be based on data relating to where the people are coming from, where they work, where they shop, where they eat, where they go for entertainment, where they live, and estimates on income based on living location and the type of habitual destinations (e.g., certain bars, restaurants, sporting events, ski resorts, or other). The data to facilitate such processing and person identification tagging can be performed by processing the travel route and travel pattern information to build a statistical model to determine the habits of the person. Such habits can be used to make a lot of estimates, such as income level because persons that frequent lower economic establishments can be distinguished from people that frequent expensive establishments.

In another embodiment, the route of travel of a unique MCD from an origination location (e.g., home or work) to a vehicle parking facility of a destination location can be used along with the time of staying at a destination so that economic impacts of the people can be determined because some people will be workers and some will be shoppers. It may be important for planning and parking facility rules and regulations to determine the allotment and/or location of parking for workers compared to parking for shoppers. In an example, a municipality may be interested in false parking pressure where they have people who work near a parking facility or live near the parking facility taking up parking spots that the municipality would prefer to be used by visitors who are spending money at stores around the parking facility. The travel route and pattern data for the MCDs can be used to determine and distinguish between residents, workers, and shoppers. Such information can be used to configure the traffic to the parking facility as well as rules for the parking facility. Such data processing can provide meaningful information to allow a municipality to configure or control traffic, economic development, special events management, municipality planning, and parking information based on real time data and historical data. This data processing can also provide meaningful information to entities interested in advertising to the different people sets, such as residents, workers, and shoppers, so that advertisements can be pushed to these different people sets at appropriate locations, times, and durations.

In one embodiment, the data processing can determine that a group of MCDs may be present at certain events at one location and certain events at a second location. As such, once the MCDs congregate at the first location, then advertisements for the second location can be pushed to advertisement boards (e.g., electronic billboards, application advertisements on the MCD, or other) that are at the first location. In a specific example, the first location can be a basketball stadium and the second location can be a soccer stadium, and when the MCDs congregate at the basketball stadium then advertisements for the soccer stadium can be pushed to advertisement boards at the first location, which can be useful for people that are both basketball and soccer fans. Other establishments that are different can be linked together by a high volume of common MCDs going to events at both establishment locations. Also, a plurality of different establishments may be linked together by a high volume of common MCDs.

In addition to travel routes (e.g., highways, surface streets, sidewalks, bicycle paths, etc.) the signal tracker systems can be deployed within destinations so that different areas of the destination can have different signal trackers. Such destinations can be stores, restaurants, parks, stadiums, arenas, resorts, ski resorts, theaters, malls, parking facilities, shopping centers, golf courses, congregation centers, churches, schools, buildings, hospitals, recreation centers, gyms, event centers, offices, apartment/condo/townhouse complexes, neighborhoods (e.g., public and private), or any other destination where MCDs congregate together, possibly at the same time, and sometimes for similar durations (e.g., for events). The movement within such destinations can be tracked as well as the duration of the MCD staying still or in a defined location, such as a seat at a theater or stadium, which allows for targeting advertising to the MCD or groups of MCDs with similar travel and behavior patterns. In one example, a stadium may have electronic advertisement boards, and the data can be processed to determine when to push certain advertisements based on the MCDs or probability of the MCDs being in a location to view the advertisement board. The parameters that define the person having the MCD or groups of people may also be factored, such parameters being described herein. For example, the advertisement can be pushed to a center board when people are in their seats or likely to be there, or pushed to boards near concessions when people are purchasing concessions or likely to do so. As such, certain advertisement boards can have a higher fee at certain times compared to others because of the enhancement in targeted advertising based on the real time and/or historical data for MCD location as well as person parameters. The advertisements can even induce people to enter information into their MCD to verify viewing of the advertisement, such inducement being to receive coupons, discounts, free gifts, or other perks or benefits for entering the information. Destinations may also have applications on the MCD to facilitate the data acquisition and processing, and thereby facilitate targeted advertising.

In one embodiment, the traffic system includes an application installed and operating on the MCD. This application can be used to obtain information as well as provide information to the user of the MCD. The information can be advertisement information, traffic information, travel time information, or any other information. The application can provide maps that show the location of the signal trackers, or the signal trackers can be hidden. The map may show the location of MCDs being tracked or show areas of congestion or light concentration of MCDs. The application can push the targeted advertisements to the MCD when the MCD is in a certain location and/or at a certain time. The application can push targeted advertisements to one or more selected MCDs based on the real time or historical travel routes and travel patterns. The number of MCDs receiving pushed advertisements can also be used to determine the value or cost of the advertisement. The map can also show historical traffic patterns and traffic density for locations, where the map can be interacted with to select showing certain times of day or certain days of the week. This can allow the user to look up historical and estimated traffic for a particular route or location for any given time on any given day, such as weekdays and weekends. For example, a person may be interested in the traffic history for a route from a first location to a second location for rush hour on Mondays, and such information can be selected and presented to the person on the map. This may be helpful in determining travel routes as well as in decisions of where to live or work.

In some instances, third party applications can push information, such as advertisements, based on the data obtained and processed by the system described herein. For example, a business may have an application that can be installed on an MCD, then the system can provide traffic pattern data to the business, and the business can push information to the MCD via their own application. The business can also provide incentives for customers to opt-in to having their MCD provide data to the business and/or traffic analysis system, which can allow for improved informatics. The opt-in may also include personal information, which may be handled within legal boundaries.

In one embodiment, the signal tracker or the SCS can process the data to remove identifying data. In some instances, there may be laws, rules, or regulations regarding the type of information the SCS can process or retain, and any other information can be tagged and discarded. The signal tracker system can be configured to only collect anonymous data relevant to the unique identifiers of each MCD, but personal information about the user or other data may be discarded at the signal tracker or at the SCS.

In one embodiment, the signal tracker system may or may not have signal tracker zone overlap. In any event, the signal tracker system can employ triangulation or trilateration to pinpoint the location of the MCD, and thereby the person. Such triangulation or trilateration can be performed at the signal tracker or at the SCS. The signal trackers can record the travel speed at a given signal tracker as well as the signal tracker system tracking an MCD across multiple signal trackers to calculate the travel speed.

In one embodiment, a unique MCD can be tracked everywhere it goes in a signal tracker system or across multiple signal tracker systems (e.g., a signal tracker system for each city, and travel through multiple cities, or even states). The MCD can be tracked daily to determine routines or common travel routes and travel patterns. Over time, the system can predict when and where the MCD will go based on the historical data. The same processing can be done with groups of MCDs with common originations, common travel routes, common destinations, or any other commonality. The same processing can be done to parse out MCDs from a common vehicle, which may be used to establish predicted relationships between the MCDs. For example, two MCDs may not have common traffic routes or patterns, but they may arrive at a common destination in the same timeframe on repeated occasions, where the common destination may be constantly changing or staying the same, and thereby the system may determine that MCDs are owned by people that are acquaintances or share common interests. Over time such information can be used for mapping social connections of people having the MCDs.

In one embodiment, when an MCD goes to a particular destination each weekday from a start time to an end time, it may be determined that the MCD is owned by a worker at the destination. This type of data can be filtered from data of an MCD that only shows up to the destination once or on a few occurrences, and at different times, which may indicate a customer. The employee can be pushed different advertisements compared to the customer. Often, the processing will be for groups of MCDs and preferably large groups, such as those at a common event. The historical data can give behavior trends for a group of MCDs that can be used for targeting these MCDs for advertisement purposes.

In one embodiment, the system can partition MCDs into groups with similar behaviors. The groups can be employees, visitors, tourists, residents, or any other similarity. The groups can also be the MCDs that are determined to travel in a particular route at a similar time during the same days of the week, such as the rush hour commute. For example, if a certain MCD has not been detected in a signal tracker system for a geographical location (e.g., city), the MCD may be owned by a tourist. This can allow for filtering this MCD from those that are determined to belong to different groups. Some groups can be more relevant to some businesses compared to other groups or other businesses.

In one example, a municipality may be interested in the different types of people (e.g., people groups) that go to Main Street. So, initially they're interested in when people are coming to Main Street, where they are on Main Street, and how long they stay on Main Street, and when they leave Main Street. The system can filter shoppers from employees based on real time and historical traffic data. The people who go to Main Street consistently in a consistent manner are often employees. People who are coming in from another town and only stay a short time are likely shoppers. The system can track the people via the MCDs and make various determinations and estimates for these people and what they are likely to do on Main Street. Once a traffic pattern can be determined, advertising can be pushed out to certain locations (e.g., electronic boards) at certain times, and then the traffic pattern post advertising can be analyzed to see if there was a change in the traffic pattern based on the advertising. Such analytics can be used to provide for costs of effective advertising, and determine when advertising is more effective to change a traffic pattern routine for one MCD or a group of MCDs. Also, there can be dedicated parking facilities for Main Street, and the system can track the MCDs to determine the MCDs going to Main Street, estimates of what percentage of people are employees taking up parking spots, visitors taking up parking spots, when the parking facility is full or empty or with sufficient space, what these people do after they park, where they go, where they eat, where they shop, and other information. This information may be useful to push targeted advertisements to turn visitors into customers.

The municipality may be interested in the impact of events, such as how summer concerts impact traffic on Main Street, and on parking for those events before, after, and during the event. The system can track and analyze the data to provide such information. The municipality can implement a change between events and then a determination can be made as to how the change modulated the traffic and parking. This allows for putting changes into perspective as to the effect on traffic and parking, and then additional change iterations can be made until the municipality obtains a desired traffic and/or parking pattern.

In one example, a location may have a certain traffic and parking pattern before arrival of a new store, and then a different traffic and parking pattern after the store. The system can record and analyze the traffic and parking patterns for a determination of the economic impact to the area having the new store, which may be a positive economic impact for some stores and a negative impact for other stores. Such information can assist in determining which types of stores should be clustered with each other or separated from each other. The same type of analysis can be performed with any changes, such as a new advertising campaign by a store. This can be used to allow for analyzing traffic and parking patterns based on events or changes in events.

The system may also be implemented with mass transit systems (e.g., trains, buses, or the like and combinations thereof) to see the effectiveness of certain programs. This can allow for the mass transit system to have schedules adjusted based on the traffic patterns, and then reassessed to see if there was an improvement in the traffic pattern after the schedule adjustment. The systems can be used to improve traffic flow. The signal trackers can be in static locations, such as terminals and stops, or on moving vehicles like trains or buses. The signal trackers can have a GPS module for static or dynamic tracking of the signal tracker.

In one embodiment, the signal tracker system can receive signals from devices other than MCDs, such as static devices like personal computers. The system can detect any device that emits a detectable signal, and based on the historical detection of such a signal, the system can determine if the signal is from an MCD that can move around or if it is from a static device, such as a personal computer. The system can detect a large number of MCDs and other devices every second and filter out the devices so that only relevant MCDs are recorded and processed by the SCS. The signal tracker can purge the data from the database once the data is uploaded to the SCS. This allows for rapid detection of unique MCDs.

The signal trackers can also use cameras or microphones with a method of identifying a person's clothes, face, or the sound of their voice, or the like. The signal trackers can use weight sensors, laser trip counters, or any other method of determining the volume of people moving through a location, which could be used for volume analysis. The signal trackers can use GPS data from an MCD or other electronic device, if the person opts-in to allowing collection of such data. The signal trackers can obtain signals and data from connected cars (e.g., vehicles that come with 3G and GPS or other data connection). The systems may also use data from some other source, such as third parties or applications on the MCD. The signal trackers can also get data from city buses or other vehicles as they move around the city.

In one embodiment, the signal trackers can be set in a location near a WiFi provider. This may draw people with MCDs to the location to use the WiFi from the WiFi provider, and then the information can be collected. The uses of the WiFi provider may opt-in to allow for their data to be collected, and possibly provide personal data to bolster the database and information for a particular unique MCD, which can enhance tracking and data analysis.

In one embodiment, the system can be used to distinguish different people from each other even if they travel together or have the same travel route or travel pattern. The person may have one or more MCDs, which they often carry together. This allows the system to track these MCDs and verify the same travel route or travel pattern over a defined historical period, and thereby these MCDs are linked to a common owner. As such, each time one of these MCDs is detected, only one is tracked for traffic purposes because they are all indications of the same person. Similarly, multiple people can travel together for the same travel route or travel pattern, such as on a bus, train, or carpooling. However, in most instances there will be some divergence in the travel so that the MCDs separate and go in different directions, and this allows to determine unique MCDs for unique people. The statistical association of MCDs and statistical dissociation of MCDs can be used to identify a unique person with one or more MCDs from other unique persons. This allows for the data processing to provide a more accurate assessment of traffic based on unique people (e.g., possibly having multiple MCDs) instead of unique MCDs.

The traffic being detected and analyzed can be any traffic, such as mass transit traffic, vehicle traffic, bicycle traffic or foot traffic. Each can be analyzed separately based on conglomeration of MCDs, and rate of travel, where different modes of travel often have different speeds and/or different numbers of MCDs traveling together. Buses hold more people than cars, cars travel faster than bicycles, and bicycles travel faster than pedestrians.

In one embodiment, the data analysis of the travel data from one or more MCDs can be used to determine road conditions. The road conditions may be estimated by the number of travelers on a given road portion. The road conditions may also be entered into an application and provided to the system. The travel data can be used to determine the number of miles or vehicles driven on a road, and can estimate a road usage for a given portion of a road. The estimated road usage can be used to estimate the road condition. The travel data can be used to predict the condition of the road based on the usage over a given period of time. The travel data can be used to predict maintenance issues, such as pot holes, weathering, ruts, divots, or other poor road conditions that may need maintenance. The travel data can also be used to predict when the road will need to be resurfaced or other maintenance. The system can provide alerts to the travelers as well as an entity responsible for maintaining the roads, such as a city or department of transportation. The system can provide alerts regarding roads conditions, maintenance issues, construction, mileage driven on road, number of uses for a given period of time, predict total traffic. The alerts may be texted to MCDs or sent via email or via an application on the MCD. The traveler may register the MCD with a service to receive such alerts.

The system described herein can be used to detect and track anonymous identifiers in order to analyze human traffic patterns to provide information to entities, such as businesses or municipalities or consumers.

The system uses the MCDs to provide information to the signal trackers that connect with any network in any way of communication to a central area where the system has one or more central computing areas for analytics. The central areas perform some analytics on the data obtained by the signal trackers from the MCDs, and then provide meaningful analyses on the traffic patterns and what the traffic patterns mean. The data can be filtered a myriad of different ways for whatever information a certain entity may want to know. The signal trackers can pick up the information, do some filtering, do some processing, and then pass data onto the server, and the server gets that information and does the bulk analysis by running algorithms. The system can modulate the data that is being analyzed based on input that is selected or received from an entity.

The signal trackers can also be controlled by the SCS, or by a user that interfaces with the signal trackers. The signal trackers include the signal tracker computer, which allows for updating, and providing operational instructions. For example, the signal trackers may be only concerned with pedestrian traffic, and thereby can be programmed to filter out and exclude data from MCDs with high velocities, or vice versa for instances where pedestrian traffic should be excluded. Also, the signal tracker can be configured to ignore any static devices that do not move but that sends out signals that can be detected by the signal trackers, which can be useful to filter out static devices in an office building.

In one embodiment, the signal trackers can include a tracking device. This can be helpful in theft deterrence or signal tracker reclamation after being stolen. For example, if the signal tracker is moved, it may provide real time information about its location, such as by providing the GPS data or emitting a signal that indicates it has been stolen or moved. The signal tracker might turn on, validate itself, and check whether it has been stolen. If the signal tracker is in the correct location then it is not stolen. If the signal tracker asks for a validation code, the server can send the code and the signal tracker can determine if it is in the proper location. If the signal tracker were to power off or be indicated as being stolen, all of the data that was stored, even proprietary code for operation of the signal tracker, in volatile memory can be erased. The signal tracker may also include a self-destruct mechanism to destroy operability upon a command received from the SCS or authorized entity, or if it determines it is not in the proper location or has been stolen. The new GPS coordinate for a miss-located signal tracker may also be uploaded to the SCS so that the signal tracker can be found.

The analytics are in real time or on historical data. There is a class of analytics that are important for real time, such as major events like concerts or sports games with a large number of people in a certain location. This may be helpful for a municipality to send police officers to manage the event in real time. Also, there is a class of analytics when the data processing is more focused on traffic from an event and the traffic gets congested at a traffic light, and where there may need to be proactive operations to alter the operation of the traffic light to improve the traffic flow, which can be in real time or based on historical traffic patterns for similar events. The system is concerned with analyzing the data and providing information regarding traffic volume at the traffic light, and optionally the system has precomputed a traffic pattern based on historical data and on historical trends. This allows the system in real time to perform analytics to identify an event is occurring, and then trigger a precomputed sequence of operational parameters for the traffic light to improve traffic flow. This allows the use of historical analytics to impact traffic in real time in order to change the traffic flow in real time or to make notifications in relation to certain events.

For example, the system can push information to an entity, such as notifying a business, when the real time data based on a historical trend indicates they will get a large influx of customers. This can assist the entity to reconfigure operations or obtain assistance to handle the influx of customers to that the entity is not overwhelmed. This type of data analysis can be based on a real time occurrence that maps and matches some historical event that has been analyzed before. The system can provide real-time alerts to the entity. For example, the notifications can tell a mass transit system that a train isn't on schedule, or it can automatically suggest more employees go to a busy area of a resort. This allows real time operational adjustments based on real time data analyzed in view of historical data. Such analytics may not be based on a unique MCD, but on a certain number of unique MCDs that are in a common location or have a common traffic pattern.

In one embodiment, the signal trackers and SCSs can have software technology for implementing the protocols described herein. The software can be an API. Also, the signal trackers can be integrated with other devices that are commonly found in traffic areas, such as traffic lights, street lights, power stations, power boxes, or other. For example, a traffic light or street light can be manufactured to include an on-board signal tracker, and thereby the signal trackers can be deployed when the traffic light or street light is installed. In non-limiting examples, the signal trackers can be integrated and embedded: in traffic lights, whether custom traffic lights, or those of other manufacturers; street lights that can have an OEM model where existing lighting manufacturers embed the signal trackers; or unique street lights can be manufactured with the signal trackers. Also, the signal trackers can be a 120 v or 220 v “dryer outlet” style device that is about the size of a water bottle. This can allow for the removal of a photovoltaic sensor on a street light and replace it with a signal tracker unit that also has the same function. Accordingly, this can allow for remote control and timing of the street light, such as turning them all on or off, making them all flash, or any other function.

As described herein, the data that is collected from the system can be analyzed to determine various metrics. The information obtained from the analytics can be used for various purposes, such as to improve traffic flow, determine the type of travelers in traffic, determine the origination area of travelers for certain travel time periods, determine the destination area of travelers for certain travel time periods, determine destination habits for travelers, determine targeted advertising for traveler groups, or to determine advertising rates for selective traveler group targeted advertising.

In one embodiment, the data can be used for analytics regarding travel time calculations. That is, the real time and historical data can be used to determine real time travel time from an origination point to a destination point for a traveler for the mode of transportation for the traveler. This can include travel time duration of travel estimates for bus, train, car, bike, or walking, or other mode of transportation. The data from a first signal tracker can be processed to determine the rate of travel proximal the first signal tracker, which allows for an estimation of the current mode of transportation, which can be compared to other modes of transportation for the MCD of the traveler as well as other rates of travel from other signal trackers in the travel route that have identified the MCD of the traveler. The route of travel can then be used to estimate the next signal tracker that will detect the MCD of the traveler. The information can determine the time it takes to get from location A (e.g., near one signal tracker) to location B (e.g., near another signal tracker) either by car, bike, or walking. The data for one MCD can be compared to data for other MCDs that may have similar travel data. The processing can separate out MCD data for MCDs in cars, bikes, walking by speed, route, or the like, and the similar modes of transportation can be grouped into various different groups related to that mode of transportation, and the different modes of transportation can be separated into different transportation mode groups. The data can be processed to determine the average and mean travel times between two locations, and can find commonly taken routes between these locations with a predicted travel time between the two locations. The predicted travel times as well as the average travel times can be based on certain travel periods, which can be for example during morning rush hour on a select day of the week, or the like. Each travel period can be determined by time increments for select periods for each day. For example, traffic at a first route on Monday at 8 AM may be different from traffic on that first route on Monday at 7:45 AM and 8:15 AM, and thereby each travel period for each day can be mapped and analyzed separately. Such information can be used for predictive traveling.

The data processing can be performed to determine MCD associations with a common person and MCD dissociations between different people that they may travel at least part of a travel route together. That is, by analyzing real time and historical travel data, a person can be defined to have multiple MCDs. Also, by analyzing real time and historical travel data, people that travel at least part of a travel route can be distinguished between each other, such as for example by mapping divergences. This can be useful for distinguishing between friends that travel at least part of a travel route together, such as walking together or being in the same car for a portion of each traveler's entire travel route. While real time data can be useful, historical data can be analyzed to show multiple MCDs and people that are frequently seen together by the signal tracker (e.g., signal tracker detecting the MCDs at the same time for the same duration). This data analysis can also be useful for grouping multiple MCDs together for a common person that has the multiple MCDs, such as a person with two phones, a phone and tablet, or any other combination of signal emitting devices that can be considered to be MCDs. When multiple MCDs are grouped to a single person, the Wi-Fi, BT, and cellular signals may be grouped to a person instead of being counted as different people. Such data processing can increase the accuracy of the data analytics.

The data processing can be used to implement city wide (e.g., metro area or any geographic area) traffic calculations. The data processing can be used to determine optimal traffic light timings for certain traffic patterns and traffic flows. This optimal traffic light timings can be updated daily, hourly, or even every minute or shorter period to improve total traffic flow for a particular road, or route, of combinations such as for multiple roads with intersections, and for cross-traffic. Such data processing can be based on historical data and real time data that shows current traffic patterns and trends. The timeframe for the optimized traffic light timings can be specific to that day of week (e.g., weekday, Monday, Tuesday, Wednesday, Thursday, Friday, weekend, Saturday, Sunday), holiday or pre-holiday traffic (e.g., New Year's Day, Easter, Mother's Day, Father's Day, Memorial Day, Independence Day, state holidays, Labor Day, Thanksgiving, and Christmas), or even specific days of the year. The data processing can allow for a municipality or other entity that controls traffic lights and patterns to create pre-calculated traffic light responses to real time traffic surges based on historical data, which can set new timing light sequences until the real time traffic surge subsides.

In one embodiment, the processing of the travel data can allow for general identification or prediction of the type of person having the MCD based on historical travel patterns, originations, destinations, time frames of travel, time frames of being stationary, or other information. The identification or prediction can be based on an estimation of “person types” associated with the behavior. This allows the system to associate an MCD with a “person type” category based on historical trends in their travel patterns. In limited examples, the person type can be: local resident (e.g., someone that lives close to or in the geographical area monitored by the system), local worker (e.g., someone that works close to or in the geographical area monitored by the system); regional visitor (e.g., someone that lives outside the geographical area, but close to it, and may periodically be within the geographical area); or long distance visitor (e.g., someone that lives a long distance outside the geographical area, and may only be detected in the geographical area once, or a few times a month or year or over the years). Often, long term data accumulation and analysis is needed to determine a long distance visitor because they rarely are within the geographical location. The person type may also be related to the number of times within a period of time the person is within the geographical area, such as daily, weekly, monthly, or yearly, and how long of a stay within the geographical area ranging from minutes to hours, whether being at the same location for a set period of time (e.g., worker) or only being present for a short period (e.g., shopper). Such data processing can be based on detecting the MCD at set times (e.g., 9 AM-5 PM Monday through Friday; however swing shifts and abnormal shifts may also be identified), frequency of detection, location of detection, or other parameters.

One aspect of a person type may be an estimation based on data from multiple cities or multiple signal tracker systems. This can be performed when an MCD is detected in multiple signal tracker systems along with the time and duration the MCD is in one signal tracker system compared to another signal tracker system. The system can associate signal trackers from one signal tracker system (e.g., first metropolitan area) with other signal trackers from a different signal tracker system (e.g., second metropolitan area). This allows for the system to have different signal tracker systems in different cities, where, in an example, a local resident in city A is a regional visitor to neighbor city B, and a long distance visitor in city C. The way the system uses anonymous data such as the MAC address and signal strength and duration of detection, the system can categorize MCDs to person types even if the person is anonymous.

The data processing can use the location of travel originations to determine a home address area, either a specific address or within a defined address area, and can also determine a work address. One or both of these parameters together with information about the demographics of the travel originations and addresses can be used to determine the socioeconomic status of the person, such as their income or ethnicity, as well as other information. Also, the work address as a destination may also be useful in determining the socioeconomic status of the person, where differences in restaurants or store work places can be contrasted with professional work places, such as law firms or accounting firms. Also, the comparison of origination information (e.g., home) with destination information (e.g., work) can also be performed to estimate the person type and other information. The association of characteristics based on demographics of home, work, or the like can be used to determine spending habits or targeted advertisements. The information can be used to identify groups of associated people who live, work, and/or play in similar locations. Then the system can process the demographic information related to those locations, to estimate average income, age, and gender distributions, and then make some statistical assumptions about who these people likely are in order to estimate a person type.

In one embodiment, the data described herein can be processed to identify advertising metrics, which allows for targeting advertisements to persons with certain habits or travel patterns. The data can be processed and linked to estimated behaviors. The information can be processed to inform businesses or other entities about who is visiting their store, seeing their billboard, or passing their store or billboard without personal identifiable information being used.

In addition to the travel data, the system can obtain other data relevant to the MCD. This may include collecting demographic information based on manufacturer of the MCD. The processing can then overlay the travel data with the outside information in order to characterize the owner of the MCD, and thereby the travel data and outside information can be used to make an estimation of the person type.

In one embodiment, the travel data can be combined with weather data. This can allow for making determinations based on like weather conditions, and omitting or filtering out different weather conditions compared to the weather of a target timeframe. This allows for matching travel data with weather data. This can improve the analysis so that similar conditions for a travel route or traffic pattern can be compared together. For example, traveling in the summer sun is significantly different from traveling in winter snow, and modulations of the data analysis with weather conditions can improve all aspects of the data processing, such as for traffic control or targeted advertising. Also, travelers in certain weather conditions and in certain travel routes can also be used for demographic analysis. For example, persons traveling to a canyon with a ski resort in snowy conditions are likely to be targets for the winter outdoor gear industry.

In one aspect, the travel data can be used to identify connections to residence addresses, such as the ZIP code, street, or specific address of origination of a travel route. This information when combined with the travel data can be used for estimating the average income of a person with the MCD.

In one aspect, the travel data can be used to identify types of commodities and/or wealth status. The travel data can be combined with map data that has identifications of business types and store types, and visits to certain businesses and/or stores can identify the types of products the person may desire. This allows for targeted advertising. The data processing can combine the travel data with the destination data (e.g., business or store) in order to identify products or types of products or level of cost of products that the person may want so that advertisers can target that person as well as persons in groups with that person. For example, when an MCD visits a certain destination (e.g., Mercedes Dealer), the data processing can make inferences from that data. For example, a person that visits a Mercedes dealer likely has more income that a person that visits a Kia dealer, and thereby likely to have more disposable income to purchase more expensive items, stay at fancier hotels, and eat at more expensive restaurants. This allows for the type of commodity sold at a destination to be placed into a cost stratification for grouping purposes and for targeted advertising.

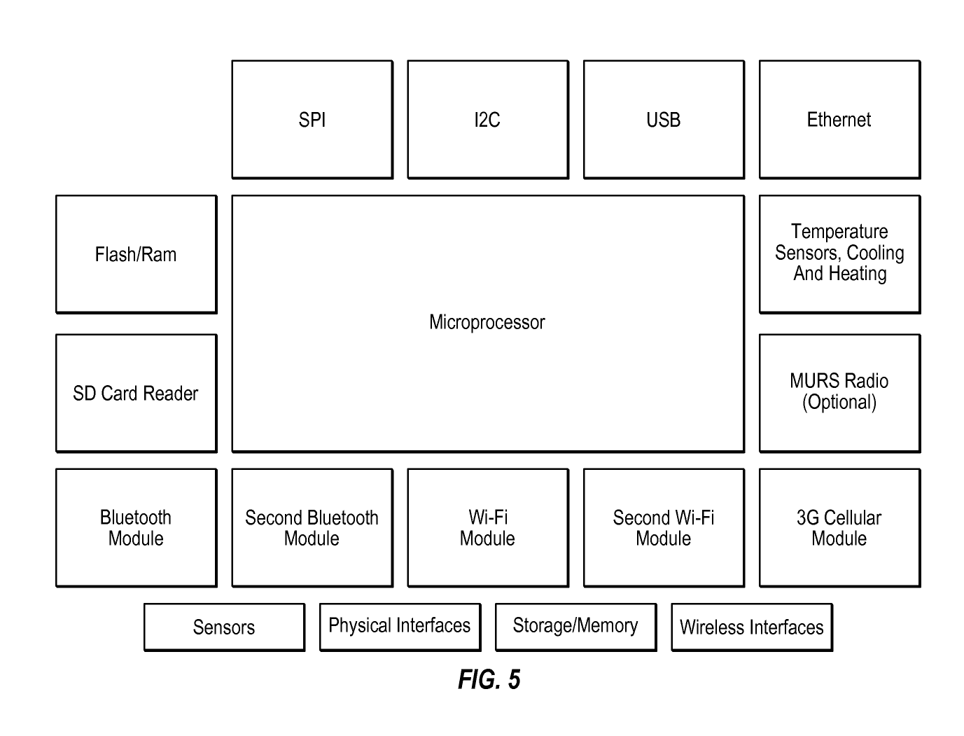

FIG. 5 illustrates an embodiment of a signal tracker and its components.

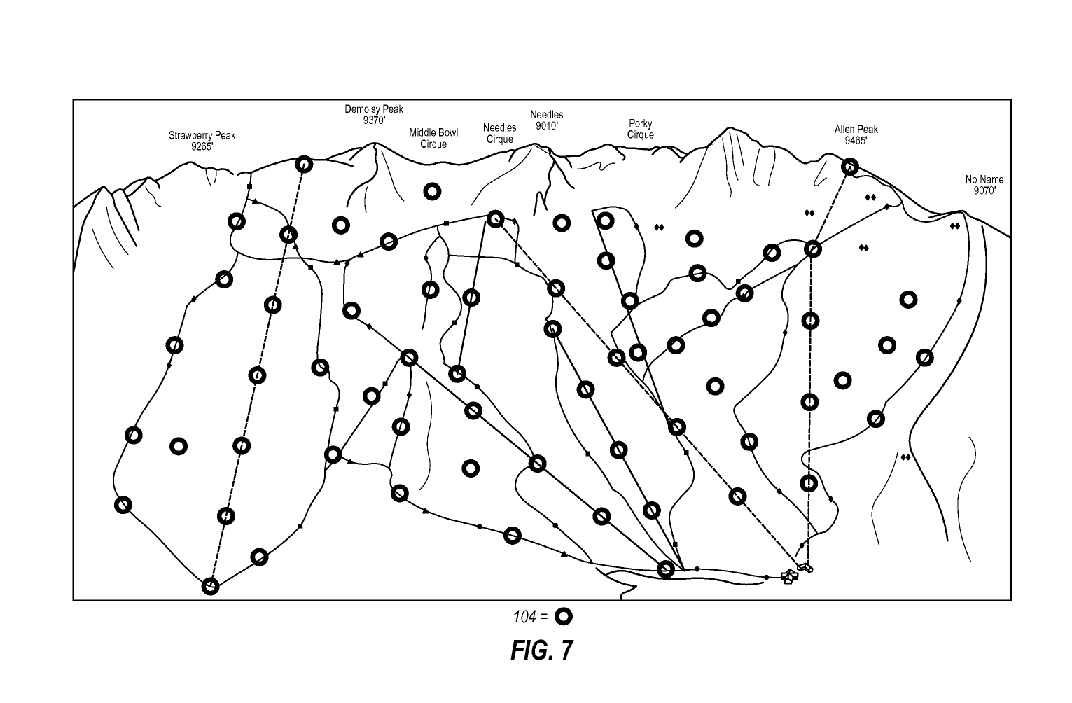

FIG. 7 illustrates a ski resort having signal trackers (black donut) on lifts and runs.

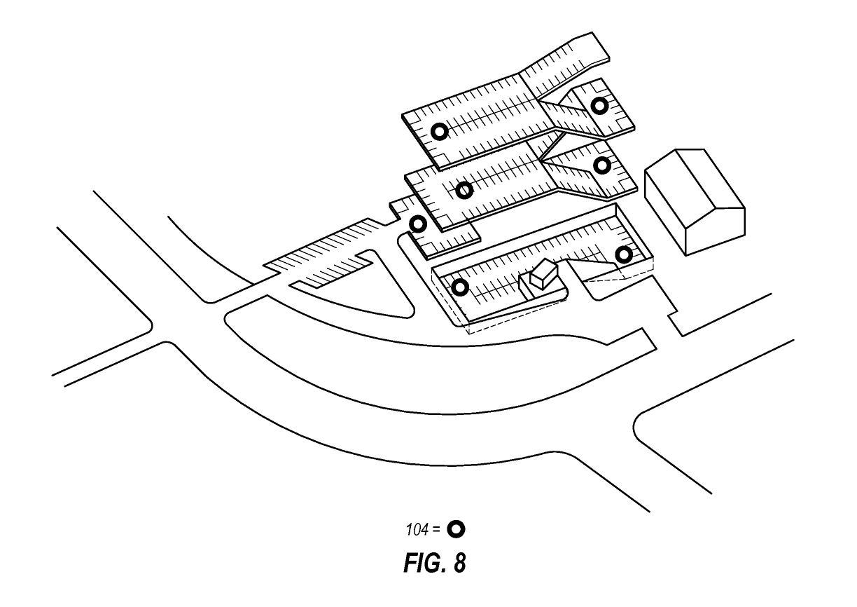

FIG. 8 illustrates a parking facility having signal trackers.

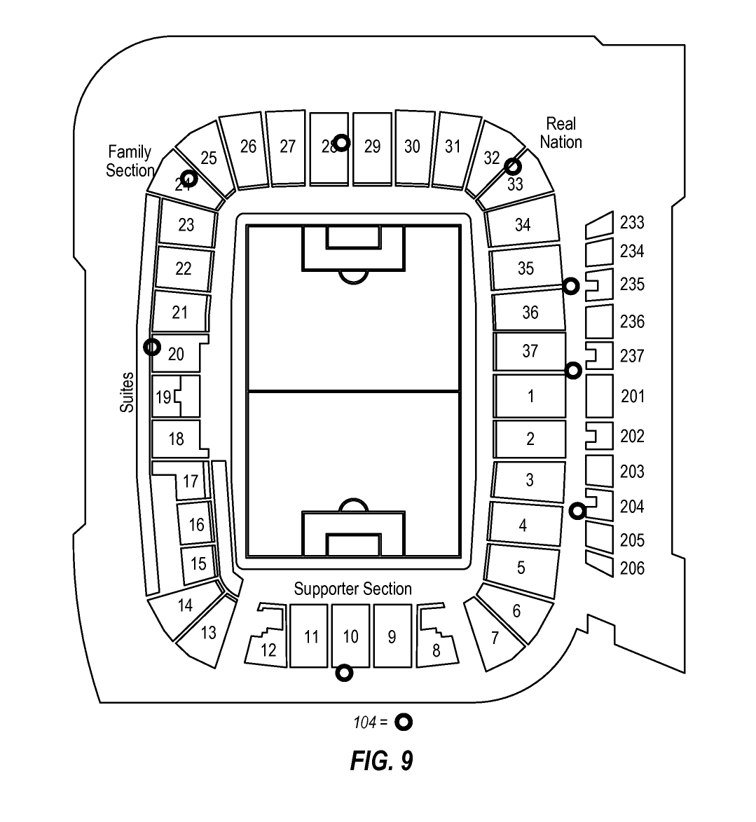

FIG. 9 illustrates a stadium having signal trackers.

In one embodiment, a method of travel analytics can include: detecting a signal of a first mobile computing device (MCD) at a first location with a first signal tracker; and obtaining real time travel data about the first MCD from a signal received by the first signal tracker; accessing a database having historical travel data for the first MCD; comparing the historical travel data with the real time travel data for the first MCD to determine travel data for the first MCD; analyzing the travel data for the first MCD with other MCDs; determining one or more travel data groups; grouping the first MCD with one or more other MCDs into one or more data groups. The travel analytics method can include: determining a mode of travel of the first MCD; predicting a travel route for the first MCD; or predicting a time of travel for the first MCD on the predicted travel route to a second signal tracker. The travel analytics method can include: detecting a signal of a second MCD at the first location with the first signal tracker; and obtaining real time travel data about the second MCD from the signal received by the first signal tracker.

In one embodiment a travel analytics method can include: determining a mode of travel of the second MCD; and if the mode of travel of the second MCD is the same as the first MCD, the first MCD and second MCD are grouped into a first travel mode group, if the mode of travel of the second MCD is different from the first MCD, the first MCD is grouped into a first travel mode group and the second MCD is grouped into a second travel mode group.

In one embodiment, a travel analytics method can include: predicting a travel route for the second MCD; if the travel route for the second MCD is the same as the first MCD, the first MCD and second MCD are grouped into a first travel route group, if the travel route for the second MCD is different from the first MCD, the first MCD is grouped into a first travel route group and the second MCD is grouped into a second travel route group.

In one embodiment, a travel analytics method can include: predicting a time of travel for the second MCD on the predicted travel route to a second signal tracker; and if the time of travel for the second MCD is the same as the first MCD, the first MCD and second MCD are grouped into a first time of travel group, if the time of travel for the second MCD is different from the first MCD, the first MCD is grouped into a first time of travel group and the second MCD is grouped into a second time of travel group.

In one embodiment, a travel analytics method can include: analyzing travel data for the first MCD; and predicting an origination location for the first MCD. In one embodiment, a travel analytics method can include: analyzing travel data for the first MCD; and predicting a destination location for the first MCD.

In one embodiment, a travel analytics method can include: analyzing travel data for the second MCD; predicting an origination location for the second MCD; and if the original location of the first MCD and the second MCD is within a first defined origination geographic area, the first MCD and second MCD are grouped into a first origination location group, or if the original location of the first MCD is within a first defined origination geographic area and the original location of the second MCD is within a second defined origination geographic area, the first MCD is grouped into a first origination location group and the second MCD is grouped into a second origination location group.

In one embodiment, a travel analytics method can include: analyzing travel data for the second MCD; predicting a destination location for the second MCD; and if the destination location of the first MCD and the second MCD is within a first defined geographic area, the first MCD and second MCD are grouped into a first origin location travel group, or if the original location of the first MCD is within a first defined geographic area and the original location of the second MCD is within a second defined geographic area, the first MCD is grouped into a first origin location travel group and the second MCD is grouped into a second origin location travel group.

In one embodiment, a travel analytics method can include: analyzing travel data for the first MCD; and analyzing travel data for the second MCD; if the travel data for the first MCD is the same for the second MCD, the first MCD and second MCD are assigned to a first traveler; or if the travel data for the first MCD is different from the second MCD, the first MCD is assigned to a first traveler and the second MCD is assigned to a second traveler.

In one aspect, the travel data that is analyzed is real time travel data. In one aspect, the travel data that is analyzed is historical travel data. In one aspect, the travel data being analyzed is historical travel data and real time travel data.

In one embodiment, a travel analytics method can include: determining the first MCD to be stationary or within a narrow geographical area for a predetermined time period; defining prior travel before becoming stationary as a first travel route for the first MCD; and defining travel subsequent to becoming stationary as a second travel route for the first MCD. The narrow geographical area can be: smaller than the first travel route and/or second travel route; within a building; within a business entity; within an event center; within a seat; or defined based on historical travel data where the MCD resides for predetermined time periods.

In one embodiment, a travel analytics method can include: performing any of the one or more method steps with a plurality of MCDs.

In one embodiment, a travel analytics method can include filtering the travel data to distinguish between: different modes of travel being bus, train, car, bicycle, skiing, skating, or walking; different MCDs in a common vehicle; different MCDs for a common person; different people in a common vehicle; different travel routes for a person or group; different travel times for a person or group; different origination locations for a person or group; or different destination locations for a person or group.

In one embodiment, a travel analytics method can include: determining an average travel time from a first location to a second location based on real time travel data; and/or determining a mean travel time from a first location to a second location based on real time travel data.

In one embodiment, a travel analytics method can include: determining a plurality of travel routes from a first location to a second location; and filtering out one or more of the travel routes based on real time travel data and/or historical travel data to obtain one or more optimal travel routes; and presenting the one or more optimal travel routes to an MCD of the user.

In one embodiment, a travel analytics method can include: determining a plurality of MCDs for the same traveler; and combining these MCDs so that the travel data thereof is only associated with one traveler.

In one embodiment, a travel analytics method can include: determining two or more people that travel together in one or more travel routes; and maintaining the MCDs separately for these two or more people so that each traveler is defined.

In one embodiment, a travel analytics method can include: identifying a group for a targeted advertisement; determining a travel pattern for the group; and providing the advertisement to the group during travel in the travel pattern. In one aspect, the group travels past a common location during the travel pattern, and the advertisement is provided at that common location.

In one embodiment, a travel analytics method can include: determining a timeframe that a percentage of the group passes the common location; and providing the advertisement during the timeframe at the common location. In one aspect, the percentage is over 75%, 80%, 90%, or 95%.

In one embodiment, a travel analytics method can include: obtaining demographic information related to the MCD. The method can then include processing the travel data with the demographic information in order to characterize the owner of the MCD.

In one embodiment, a travel analytics method can include: obtaining weather data for the weather for the travel route, wherein the weather data is real time weather data or historical weather data; and processing the travel data with the weather data. The method can include modulating the data analysis with the weather data. The method can include: determining a weather pattern for a target timeframe for a travel route; and determining weather for historical travel data for the target timeframe for the travel route; and filtering the travel data to remove data that is associated with a different weather pattern. This method can further include: determining a weather pattern for a target timeframe for a travel route; and determining weather for historical travel data for the target timeframe for the travel route; and filtering the travel data to retain data that is associated with a similar weather pattern to the weather pattern of the target timeframe.

In any of the methods, the signal from any MCD is selected from cellular signal, Wi-Fi signal, Bluetooth signal, or combinations thereof.

In one embodiment, a travel analytics method can include: detecting at least one signal from a plurality of mobile computing devices (MCDs) at a first location with a first signal tracker; and obtaining real time travel data about the plurality of MCDs from the signal received by the first signal tracker; accessing a database having historical travel data for the plurality of MCDs; comparing the historical travel data with the real time travel data for the plurality of MCDs to determine travel data for the plurality of MCDs; analyzing the travel data for the plurality of MCDs; determining one or more travel data groups; and grouping some of the MCDs of the plurality of MCDs into one or more data groups.

In one embodiment, a method of targeting advertising can include: obtaining data from travel analytics performed in accordance with one of the embodiments described herein; determining one or more groups of MCDs; determining a product for the one or more groups of MCDs; and selectively advertising the product to the one or more groups of MCDS while the MCDs are traveling on a common travel route during a travel timeframe. The method of targeting advertising can include: identifying a first traffic pattern for one or more groups of MCDs; implementing a targeted event in a geographical location of the first traffic pattern; performing travel analytics after the change; and determining whether or not there is a change from the first traffic pattern to a second travel pattern in response to the targeted event. In one aspect, when there is a change, the method can include determining if the change has a benefit to an entity. In one aspect, when there is a change, the method can include determining if the change is detrimental to an entity. The targeted event can be an advertisement observable while traveling in the first traffic pattern. The targeted event can be a change in a business entity. The targeted event can be a new business. When there is a benefit, the method can include increasing a cost of advertisement to the entity having the benefit. When there is a detriment, the method can include decreasing a cost of advertisement to the entity having the detriment.

The methods can be performed with a traffic monitoring system that includes: a plurality of signal trackers; a network communicatively coupled with the plurality of signal trackers; and a server computer system communicatively coupled with the plurality of signal trackers through the network, the server computer system having a database with historical travel data and having travel data modules for analyzing real time travel data and historical travel data. The plurality of signal trackers can include at least two of WiFi detectors, Bluetooth detectors, or cellular detectors. The system can include a cloud processor as part of the server computing system or in communication with the server computing system. The system can include the plurality of signal trackers being arranged so that each has a signal tracker zone of signal detection area. The signal tracker zones can be separated from each other with or without gaps therebetween. In some instances, at least two signal tracker zones overlap.

In one embodiment, each signal tracker includes one or more of: a weather-proof housing; a WiFi detector; Bluetooth detector; cellular detector, signal tracker database on a storage medium; signal tracker computer; signal tracker transmitter; connector port; cooling element; heating element; thermostat; thermocouple; cellular communicator; signal tracker receiver; and power source. The signal tracker can include a power converter that converts a natural resource into electronic power. The natural resource can be solar power or wind power.

The methods described herein can include one or more of: measuring signal strength from the MCD with a signal tracker; measuring duration of signal detection with the signal tracker; identifying start of signal detection; identifying end of signal detection; triangulating the location of the MCD relative to one or more signal trackers; or using trilateration to determine the location of the MCD relative to one or more signal trackers.

The methods can include: recording signal data from one or more MCDs with a signal tracker and storing the signal data at the signal tracker; processing the signal data with the signal tracker to obtain processed signal data; uploading the processed signal data to the server computing system from the signal tracker; and purging the signal data and processed signal data from the signal tracker.

The methods can include recording signal data from one or more MCDs with a signal tracker and storing the signal data at the signal tracker; uploading the signal data to the server computing system from the signal tracker; and purging the signal data from the signal tracker.

The methods can include: storing signal data from a plurality of MCDs on the signal tracker; uploading the signal data to the server computing system from the signal tracker in a batch upload; and purging the signal data from the signal tracker.

The signal tracker can include a computing system with a memory device that has computer-executable code for performing the operations of the signal tracker. The server computing system can include a memory device that has computer-executable code for performing analytics on the travel data obtained by the signal trackers from the MCDs.

The methods can include: measuring a weather condition at a signal tracker; determining whether the temperature is too hot or too cold relative to a desired operational temperature range; and either heating or cooling the signal tracker to the desired operational temperature range. The method can include the determining of the temperature being performed at the signal tracker or at the server computing system.

The methods can include: plugging a computer device into a signal tracker; and uploading software onto the signal tracker.

A signal tracker system can have a plurality of the signal trackers located in one or more of: a metropolitan area; a city; a county; a rural area; a highway road system; a surface street road system; a park; a parking facility; a shopping center; a store; an office building; a stadium; an event center; a ski resort; a lake; an amusement park; a bike path; or combination thereof.

The methods can include: detecting a plurality of MCDs at a signal tracker in a defined timeframe to obtain real time travel data; comparing the real time travel data at that signal tracker with historical travel data for that signal tracker; and determining traffic volume for that signal tracker at that timeframe. The method can also include: identifying a potential advertisement; identifying a target group to receive the potential advertisement; identifying an advertisement location for the potential advertisement that is passed by the target group; and identifying a timeframe for presenting the potential advertisement to the advertisement location at the timeframe. The method can include determining an advertisement rate for the potential advertisement at the advertisement location and timeframe based on the traffic volume of the target group.

The methods can include operating a traffic monitoring system by using a plurality of signal tracker systems to detect MCDs, the plurality of signal tracker systems having a system in different metropolitan areas. The different metropolitan areas can be in different cities. The different metropolitan areas can be in different states.

The methods can include: detecting initiation of a traffic pattern consistent with an event type; accessing historical traffic patterns that correspond with the event type; and determining the traffic pattern for the event type to be in progress.

The method can include providing information regarding the traffic pattern to an entity. Then, the entity can implement a change in operation based on the traffic pattern.

The MCD can have an application, the method comprising pushing information to the MCD based on traffic data. The pushed information can be an advertisement for an entity.

In one embodiment, a method of travel time estimation can include: detecting a signal of a first mobile computing device (MCD) at a first location with a first signal tracker; and obtaining real time travel data about the first MCD from the signal received by the first signal tracker; determining a mode of travel of the first MCD; predicting a travel route for the first MCD; and predicting a time of travel for the first MCD on the predicted travel route to a second signal tracker.

The system can be configured so that the signal trackers can communicate with the MCD by receiving data from the MCD and transmitting data to the MCD. The system may also be configured to allow the signal trackers to provide information to the MCD so that control over the mode of transit can be performed by the MCD or at least from the data from the MCD. The MCDs may use the traffic data from a signal tracker to control the mode of transits navigation and routing, as well as speed, acceleration, deceleration, stopping and response to traffic signals.

In one embodiment, the signal trackers can include transceivers that can be embedded in a traffic light. However, such use of a signal tracker including a transceiver may potentially also be useful to the other signal tracker installation stations, such as traffic lights, street lights, power poles, stand-alone units, and boxes attached to stationary objects. This can be performed when the signal trackers have transceivers that can communicate by transmission and reception of data with an MCD connected vehicle. The data can tell the MCD the color of a traffic light, and when the tight changes. The data may also provide a countdown of the traffic light change so that the MCD can provide the data to the mode of transportation to optimize starting, stopping, or traversing the traffic light. In one aspect, this configuration and communication can serve to provide data to autonomous vehicles so that the autonomous vehicle can know if the light is red, green, yellow, as well as the traffic color change pattern and light durations. This can allow for the autonomous vehicle to selectively accelerate, decelerate, stop, or maintain speed through a traffic intersection having the traffic light.

Similarly, the signal trackers can be used to provide traffic information for a specific location or route to vehicles passing by, whether autonomous or human operated. The driver (e.g., human or computer) can then use the traffic information to change or maintain their driving style and routes.

The signal tracker can provide data from the network that can allow self-driving vehicles (e.g., autonomous vehicles) to know what type of traffic is in the area. The signal trackers can provide data so that the vehicles knows what other vehicles are around them, and the proximity of the other vehicles. The data may also tell the system to collaboratively determine the driving characteristic of one or more vehicles, and provide the data to the vehicle so that the vehicle can drive according to a specific driving characteristic. The data may be determined from the signal trackers collecting data from the MCDs around them because the signal tracker can detect signals from MCDs in cars, and the MCDs can interface with self-driving vehicles through our system.

The signal tracker networks and network data can allow self-driving vehicles to know what is going on around them as each vehicle can detect signals in other vehicles. This allows each vehicle to interface with other self-driving vehicles throughout the system.

In one embodiment, the computing systems of the network can process data to identify the location of an MCD. The system can use trilateration or trilateration with two, or three or more signal trackers to essentially triangulate or trilaterate a position of each vehicle. This can be helpful to human or computer driven vehicles.

In one embodiment, the system includes a data packaging platform. The data packaging platform can include a computing system that can either retain data or can access the data collected from the systems and networks described herein. The data can be analyzed so that the owner of an MCD can be classified. The classifications can be group together into defined groups. The data packaging platform can then receive a data request for a certain characteristic, such as from an entity such as an advertiser or data analyzer. The data packing platform can respond to the request by providing data for one or more groups having the characteristic of the entity. The entity then can either interface with the data packaging platform or use their own data analytic software to reanalyze, reclassify, and repackage the data based on selected parameters. The entity can then interface with the data packaging platform to provide discrete data packages of data of MCD owners with defined characteristics. The entity can sell the discrete data packages through the data packaging platform. This will provide a platform where other companies can purchase the data produced or generated by the system, repackage the data, and sell the repackaged data through the platform to provide more valuable data having certain classifications to specific niches.

In one embodiment, a method for classification of non-moving devices is provided that allows the systems to determine MCD devices or other devices that emit signals as stationary and non-moving. The method can include a signal tracker detecting a specific MCD for a long duration, such as up to 24 hours. The system can obtain data, which is encoded as an array of bits with length 24, which represents the hours a single MCD was seen by a single signal tracker in the last 24 hours. This data is stored as a single 24 bit value in a remote key/value store. When a single MCD is observed the value is retrieved, the current hour is set to 1 and any hours since the last time it was seen are set to 0. The sum of these 24 bits corresponds to the number of hours a single signal tracker has been detected the single MCD in the past 24 hours. The MCD can then be classified as non-moving if it is consistently seen (e.g., for example 13 or more hours) by the same signal tracker over the last 24 hours. This classification can then be used to modify data upload and processing methodology on the server and sent to the signal tracker to modify how data on a particular MCD is filtered before reaching the server.

Also, the system can determine that a single MCD is present at a signal tracker for a defined period of time without leaving the area of the signal tracker. When the system encounters a long period of detection of a specific MCD by a specific signal tracker, that MCD can be tagged as non-moving and the MCD signals can be discarded. Also, an MCD classified as non-moving can be filtered from the MCD data of the signal tracker so that it is either discarded at the signal tracker or system.

Additionally, the system can log all non-moving MCDs and save the identifier information for the non-moving MCDs. This allows the system to retrieve non-moving MCD data to filter all MCD data to remove all data regarding the non-moving MCDs.

In one embodiment, the system can process methods for classification of a single person that has multiple devices. The method includes obtaining data (e.g., step 1) from a specific timeframe (day, month, etc.) for a specific MCD from one or more signal trackers. Analyzing the data of all MCDs time and location (e.g., signal tracker ID) and determining whether two or more MCDs are seen at the same time and location at two or more defined times and locations. The system can compute (e.g., step 2) the number of times two or more MCD identifiers are seen together at the same location and times, which can include an analysis on the specific time intervals (e.g., 1 minute) by the same signal tracker. The system can then compute (e.g., step 3) the overall number of intervals either MDC identifier was seen, and then perform the same computation (e.g., step 4) for each MCD identifier pair or triplet, or more, which may be from a person having a combination of devices, such as a smart phone, tablet, personal computer, and any other device, each of which has a unique MCD identifier. Step 4 can include dividing the results in step 2 by step 3 to get a percentage of time that these MCDs travel together. MCDs frequently seen together and rarely seen apart can be classified as the same person, and this classification can be used for analytics on the number of people (not just MCDs) which were in a given location. The same calculation can be performed to determine the frequency the specific MCDs are seen together and the frequency the specific MCDs are seen apart. High frequency togetherness with low separation indicates the MCDs are carried by the same person. High frequency togetherness with significant separation indicates the MCDs are carried by people that are traveling together. Also, smaller or variable timeframes may be used to classify groups of people who travel together (e.g., carpool, bus, etc.) for specific periods and then separate. The times of togetherness compared with normal social routines can be used to group people as strangers that travel together the separate in a routine, and group people as acquaintances that travel together and spend time at the same location together in a routine.

In one embodiment, the systems and methods can be used for classification of Workers/Residents/Visitors to a specific area. The system can obtain the data from signal trackers and transfer it to the central server system, and the multiple observations of each MCD by each signal tracker is summarized (in a separate database table) as an arrival and departure time for that MCD and that signal tracker. The system by using this information can calculate various parameters from a given specific area (e.g., defined by a group of signal trackers): a. Monthly visitation (e.g., specific days and number of days seen); b. Average daily arrival and departure time; c. Type of days generally seen (weekdays/weekends); and d. Road types used (e.g., primarily large roadways or back roads/shortcuts or specific routine combinations) based on signal tracker location. The system by using the above information can determine multiple classifications of people, such as for example: a. Worker: Frequently seen weekdays, arrives on average between 8 and 10 and departs between 4 and 6; Resident: Very high monthly visitation, and frequently uses at least some back roads; or Visitor: Low monthly visitation, frequently seen weekends, rarely uses back roads and mainly uses main roads. The MCD or person, using methods above, can then be classified as a worker, resident, visitor, etc. to a specific area defined by a group of signal trackers. The classification data and related information can be used to segregate classifications and classifications of other analytic results into defined groups for a target audience. The target audience can be tailored to obtain specific data for advertisers, municipalities, or businesses that would be interested in targeting certain classifications of people.

One skilled in the art will appreciate that, for this and other processes and methods disclosed herein, the functions performed in the processes and methods may b e implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In one embodiment, the present methods can include aspects performed on a computing system. As such, the computing system can include a memory device that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, and/or any other computing device. The computer readable medium is not transitory. The computer readable medium is a physical medium having the computer-readable instructions stored therein so as to be physically readable from the physical medium by the computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive, a CD, a DVD, a digital tape, a computer memory, any other physical medium that is not transitory or a transmission. Examples of physical media having computer-readable instructions omit transitory or transmission type media such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to, physically mateable and/or physically interacting components and/or wirelessly interactable and/or wirelessly interacting components and/or logically interacting and/or logically interactable components.

FIG. 6 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including, but not limited to, volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620 such that the work performed by untrusted computing nodes can be verified as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. A method of travel analytics, the method comprising:
detecting a signal of a first mobile computing device (MCD) at a first location with a first signal tracker;
obtaining real time travel data about the first MCD from the signal received by the first signal tracker;
accessing a database having historical travel data for the first MCD; and
comparing the historical travel data with the real time travel data for the first MCD to determine travel data for the first MCD.

2. The method of claim 1, comprising determining a mode of travel of the first MCD based on the travel data for the first MCD.

3. The method of claim 1, comprising determining a travel route for the first MCD based on the travel data for the first MCD.

4. The method of claim 1, comprising:
predicting a travel route for the first MCD; and
predicting a time of travel for the first MCD on the predicted travel route to a second signal tracker.

5. The method of claim 1, comprising:
analyzing the travel data for the first MCD with travel data from other MCDs;
determining one or more travel data groups;
grouping the first MCD with one or more other MCDs into one or more data groups.

6. The method of claim 1, comprising
detecting signals of a plurality of mobile computing devices (MCDs) at one or more locations with one or more signal trackers;
obtaining real time travel data about the plurality of MCDs from the signal received by the one or more signal trackers;
accessing a database having historical travel data for the plurality of MCDs; and
comparing the historical travel data with the real time travel data for the plurality of MCDs to determine travel data for the plurality of MCDs.

7. The method of claim 6, comprising processing the travel data for the plurality of MCDs to distinguish between:
different modes of travel being bus, train, car, bicycle, skiing, skating, or walking for each MCD;
different MCDs in a common vehicle;
different MCDs for a common person;
different people in a common vehicle;
different travel routes for different people;
different travel times for different people;
different origination locations for different people; or
different destination locations for different people.

8. The method of claim 6, comprising processing the travel data for the plurality of MCDs to determine:
a common mode of travel being bus, train, car, bicycle, skiing, skating, or walking for two or more MCDs;
a common vehicle having two or more MCDs;
a common person having two or more MCDs;
a common vehicle having two or more MCDs;
a common travel route for two or more MCDs;
a common travel time for two or more MCDs;
a common origination location or origination area for two or more MCDs; or
a common destination location for two or more MCDs.

9. The method of claim 6, comprising:
identifying one or more common characteristics of the travel data for a first plurality of the MCDs; and
grouping the first plurality of MCDs into a group.

10. The method of claim 9, comprising:
identifying the group for a targeted advertisement; and
providing the advertisement to the group.

11. The method of claim 9, comprising:
identifying a targeted advertisement for the group;
determining a common travel pattern for the group; and
providing the advertisement at a location in the common travel pattern for the group.

12. The method of claim 11, wherein the group travels past a common location during the travel pattern, and the advertisement is provided at that common location.

13. The method of claim 5, comprising:
identifying a first traffic pattern for one or more groups of MCDs;
identifying a targeted event in a geographical location of the first traffic pattern;
performing travel analytics after the targeted event; and
determining whether or not there is a change from the first traffic pattern to a second travel pattern in response to the targeted event.

14. The method of claim 13, comprising:
determining increased traffic to a first location after the targeted event compared to before the targeted event, wherein the targeted event is an advertisement for an entity at the first location; and
determine a cost of the advertisement to charge the entity based on the change from the first traffic pattern to a second traffic pattern.

15. The method of claim 3, comprising:
determining an entity at a first location on the travel route;
obtaining an advertisement for the entity;
providing the advertisement at a second location on the travel route, the second location being passed before passing the first location on the travel route.

16. The method of claim 1, comprising one or more of:
measuring signal strength from the MCD with a signal tracker;
measuring duration of signal detection with the signal tracker;
identifying start of signal detection;
identifying end of signal detection;
triangulating the location of the MCD relative to one or more signal trackers; or
using trilateration to determine the location of the MCD relative to one or more signal trackers.

17. The method of claim 1, comprising:
detecting a plurality of MCDs at a signal tracker in a defined timeframe to obtain real time travel data;
comparing the real time travel data at that signal tracker with historical travel data for that signal tracker; and
determining traffic volume for that signal tracker at that timeframe.

18. The method of claim 17, comprising:
identifying a potential advertisement;
identifying a target group to receive the potential advertisement;
identifying an advertisement location for the potential advertisement that is passed by the target group; and
identifying a timeframe for presenting the potential advertisement to the advertisement location at the timeframe.

19. The method of claim 18, comprising:
determining an advertisement rate for the potential advertisement at the advertisement location and timeframe based on the traffic volume of the target group.

20. A method for reclassifying traffic data, comprising:
collecting traffic data that has analyzed or classified an owner of the MCD in a travel data group;
obtaining a data request for a group having a certain classification from a data repackager;
providing travel data for one or more travel data groups having the certain classification to the data repackager; and
receiving repackaged travel data from the data repackager, the repackaged data including repackaged traffic data of the owner of the MCD.

21. The method of claim 20 comprising:
redistributing the repackaged travel data; or
allowing the data repackager to distribute the repackaged travel data.
